(19) United States
(12) Patent Application Publication
(10) Pub. No.: US 2009/0244066 A1
(43) Pub. Date: Oct. 1, 2009

(54) MULTI PARALLAX IMAGE GENERATION APPARATUS AND METHOD

(76) Inventors: Kaoru SUGITA, Iruma-shi (JP); Yasunobu Yamauchi, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/409,116

(22) Filed: Mar. 23, 2009

(30) Foreign Application Priority Data
Mar. 28, 2008 (JP) 2008-086154

(51) Int. Cl. G06T 15/20

(52) U.S. Cl. 345/427

(57) ABSTRACT

An apparatus includes a unit acquiring number of first viewpoints and positions of the first viewpoints, and generating parallax image priority information which defines priority levels for each first viewpoint, a storage unit storing first-parallax images at the first viewpoints for first-resolution levels, a unit generating parallax image resolution information, which defines the first-resolution levels of the first-parallax images for the first viewpoints, by setting second-resolution levels to be a higher-resolution level for second viewpoints to be rendered, and by re-setting, if a sum total of data sizes of second-parallax images of the second viewpoints exceeds a threshold, the second-resolution levels of the second viewpoints with lower-priority levels to be a low-resolution level until the sum total becomes not more than the threshold, a unit reading out third-parallax images corresponding to the re-set second-resolution levels for the second viewpoints from the storage unit based on the parallax image resolution information.

### CROSS-REFERENCE TO RELATED APPLICATIONS

This application is based upon and claims the benefit of priority from prior Japanese Patent Application No. 2008-086154, filed Mar. 28, 2008, the entire contents of which are incorporated herein by reference.

### BACKGROUND OF THE INVENTION

1. Field of the Invention

The present invention relates to a multi parallax image generation apparatus and method.

2. Description of the Related Art

In apparatuses such as video apparatuses, home game machines, and the like, which execute real-time CG rendering, a technique called “sprite” is prevalently used. With this technique, when a CG character has a complicated shape, the CG character itself is prepared as an image, and that image is texture-mapped on a plate polygon, thus rendering that CG character at high speed without rendering many polygons that form the CG character.

In a 3D display of an one dimensional integral imaging method, which displays screen images having a parallax in a horizontal direction by overlying a lenticular sheet on a liquid crystal display, CG images from a plurality of viewpoints need to be rendered for each pixel (for example, see JP-A 2004-212666). In order to render a sprite that gives a stereoscopic view to a viewer in this 3D display, different texture images for respective viewpoints need to be mapped on plate polygons. Means for rendering different textures for respective viewpoints can use a conventional method (for example, see JP-A 2004-5228). In this specification, this method is called a multi viewpoint sprite.

Upon holding a multi viewpoint sprite on a video memory of graphics hardware, all parallax images used in display need to be stored as texture data. For this reason, the multi viewpoint sprite occupies most of the space of the video memory.

### BRIEF SUMMARY OF THE INVENTION

In accordance with an aspect of the invention, there is provided a multi parallax image generation apparatus comprising: a first acquisition unit configured to acquire number of first viewpoints and positions of the first viewpoints from display parameters, and to generate parallax image priority information which defines priority levels for each of the first viewpoints with reference to viewing area priority information given with priority levels in association with positions on a line separated by a viewing distance from a three dimensional display; a first storage unit configured to store a plurality of first parallax images at the first viewpoints for first resolution levels; a first generation unit configured to generate parallax image resolution information, which defines the first resolution levels of the first parallax images for the first viewpoints, by setting second resolution levels to be a higher resolution level in association with second viewpoints to be rendered, and by re setting, if a sum total of data sizes of second parallax images of the second viewpoints exceeds a threshold, the second resolution levels of the second viewpoints with lower priority levels to be a low resolution level until the sum total becomes not more than the threshold, the second viewpoints being included in the first viewpoints; a first read out unit configured to read out third parallax images corresponding to the re-set second resolution levels for the second viewpoints from the first storage unit based on the parallax image resolution information; and a second storage unit configured to store the third parallax images in association with the second viewpoints.

In accordance with another aspect of the invention, there is provided a multi parallax image generation apparatus comprising: a second acquisition unit configured to acquire number of first viewpoints and positions of the first viewpoints from display parameters, to accumulate a plurality of frequencies of locations of first parallax images for display positions with reference to display position information which indicates the display positions of the first parallax images in association with times, and to generate parallax image priority information which defines priority levels according to the frequencies for each of the first viewpoints; a first storage unit configured to store a plurality of second parallax images at the first viewpoints for first resolution levels; a first generation unit configured to generate parallax image resolution information, which defines the first resolution levels of the second parallax images for the first viewpoints, by setting second resolution levels to be a higher-resolution level in association with second viewpoints to be rendered, and by re-setting, if a sum total of data sizes of third parallax images of the second viewpoints exceeds a threshold, the second resolution levels of the second viewpoints with lower priority levels to be a low-resolution level until the sum total becomes not more than the threshold, the second viewpoints being included in the first viewpoints; a first read-out unit configured to read out fourth parallax images corresponding to the re-set second resolution levels for the second viewpoints from the first storage unit based on the parallax image resolution information; and a second storage unit configured to store the fourth parallax images in association with the second viewpoints.

In accordance with yet another aspect of the invention, there is provided a multi parallax image generation apparatus comprising: a first acquisition unit configured to acquire number of first viewpoints and positions of the first viewpoints from display parameters, and to generate first parallax image priority information which defines priority levels for each of the first viewpoints with reference to viewing area priority information given with priority levels in association with positions on a line separated by a viewing distance from a three-dimensional display; a second acquisition unit configured to acquire number of second viewpoints and the positions of the second viewpoints from the display parameters, to accumulate a plurality of frequencies of locations of first parallax images for display positions with reference to display position information which indicates the display positions of the first parallax images in association with times, and to generate second parallax image priority information which defines priority levels according to the frequencies for each of the second viewpoints; a second generation unit configured to generate third parallax image priority information which defines priority levels corresponding to one of the first parallax image priority information and the second parallax image priority information for each of third viewpoints, the third viewpoints being included in the first viewpoints and the second viewpoints; a first storage unit configured to store a plurality of second parallax images at the third viewpoints for first resolution levels; a first generation unit configured to generate parallax image resolution information, which defines the first resolution levels of the second parallax images for the third viewpoints, by setting second resolution levels to be a higher-resolution level in association with fourth viewpoints to be rendered, and by re-setting, if a sum total of data sizes of third parallax images of the fourth viewpoints exceeds a threshold, the second resolution levels of the fourth viewpoints with lower priority levels to be a low-resolution level until the sum total becomes not more than the threshold, the fourth viewpoints being included in the third viewpoints; a first read-out unit configured to read out fourth parallax images corresponding to the re-set second resolution levels for the fourth viewpoints from the first storage unit based on the parallax image resolution information; and a second storage unit configured to store the fourth parallax images in association with the fourth viewpoints.

### BRIEF DESCRIPTION OF THE SEVERAL VIEWS OF THE DRAWING

FIG. 1 is a block diagram of a multi parallax image generation apparatus according to the first embodiment;

FIG. 2 is a view for explaining the positional relationship between a 3D display and viewing area;

FIG. 3 is a view for explaining the positional relationship between a CG object and multi viewpoint cameras;

FIG. 4 is a view showing the contents of a multi-resolution-level, multi viewpoint image storage unit shown in FIG. 1;

FIG. 5 is a view for explaining the contents of viewing area priority information input by a viewing area-dependent parallax image priority determination unit shown in FIG. 1;

FIG. 6 is a view showing the contents of viewing area priority information input by the viewing area-dependent parallax image priority determination unit shown in FIG. 1;

FIG. 7 is a view showing the contents of parallax image priority information output by the viewing area-dependent parallax image priority determination unit shown in FIG. 1;

FIG. 8 is a view showing the contents of parallax image resolution information output by a parallax image resolution determination unit shown in FIG. 1;

FIG. 9 is a flowchart showing an example of processing of the viewing area-dependent parallax image priority determination unit shown in FIG. 1;

FIG. 10 is a view for explaining the positional relationship between viewing area priority information and multi viewpoint cameras used to determine the parallax image priority information;

FIG. 11 is a flowchart showing an example of processing of the parallax image resolution determination unit shown in FIG. 1;

FIG. 12 is a view showing the contents of a multi viewpoint sprite storage unit shown in FIG. 1;

FIG. 13 is a block diagram of a multi parallax image generation apparatus according to the second embodiment;

FIG. 14 is a view for explaining the processing contents of a multi viewpoint sprite rendering unit shown in FIG. 13;

FIG. 15 is a view for explaining the effect of the second embodiment;

FIG. 16 is a view for explaining the effect of the second embodiment;

FIG. 17 is a block diagram of a multi parallax image generation apparatus according to the third embodiment;

FIG. 18 is a view for explaining sprite display position information input by a sprite display position-dependent parallax image priority determination unit shown in FIG. 17;

FIG. 19 is a view showing the contents of the sprite display position information input by the sprite display position-dependent parallax image priority determination unit shown in FIG. 17;

FIG. 20 is a flowchart showing an example of processing of the sprite display position-dependent parallax image priority determination unit shown in FIG. 17;

FIG. 21 is a view for explaining the processing of the sprite display position-dependent parallax image priority determination unit shown in FIG. 17;

FIG. 22 is a view for explaining the processing of the sprite display position-dependent parallax image priority determination unit shown in FIG. 17;

FIG. 23 is a view for explaining a method of generating parallax image priority information based on the display regions of multi viewpoint images shown in FIG. 22 and histograms shown in FIG. 21;

FIG. 24 is a block diagram of a multi parallax image generation apparatus according to the fourth embodiment;

FIG. 25 is a block diagram of a multi parallax image generation apparatus according to the fifth embodiment;

FIG. 26 is a flowchart showing an example of processing of a parallax image priority combining unit shown in FIG. 25; and

FIG. 27 is a block diagram of a multi parallax image generation apparatus according to the sixth embodiment.

### DETAILED DESCRIPTION OF THE INVENTION

A multi parallax image generation apparatus and method according to embodiments will be described in detail hereinafter with reference to the accompanying drawings. Note that the following embodiments are premised on that components denoted by the same reference numerals perform the same operations, and a repetitive description thereof will be avoided.

In the embodiments, a 3D display (three-dimensional display) displays a sprite which has a parallax by displaying different images for different viewpoints. At this time, a problem about an increase in data size of respective parallax images to be stored in a video memory is posed. According to a multi parallax image generation apparatus of this embodiments, sprite images of a plurality of different resolution levels are prepared for parallax images of a multi viewpoint sprite, sprite images of different regions and resolutions are selected for respective viewpoints in accordance with intra-frame moving region information of the multi viewpoint sprite and a set viewing area, and the selected sprite images are loaded onto the video memory and are displayed as the multi viewpoint sprite. In this way, the multi viewpoint sprite data can be efficiently stored in the video memory.

More specifically, images of a plurality of different resolution levels are created for parallax images created by the method of JP-A 2007-96951 or the like. Then, the resolution in a sprite image is selected for each viewpoint using viewing area priority information that defines a region that allows a viewer to observe a multi viewpoint sprite with a high resolution, the statistical values of display frequencies of the multi viewpoint sprite, and viewing area optimization information of JP-A 2004-212666. After that, each selected sprite image is loaded onto the video memory and is displayed.

According to the multi parallax image generation apparatus and method of this embodiments, the video memory size occupied by the multi viewpoint sprite can be reduced compared to a case in which the multi viewpoint sprite is held in the video memory to have a high resolution in association with viewpoints to be rendered.

### First Embodiment

This embodiment will explain a case in which viewing area priority information and display parameters are input, the resolutions of respective viewpoints of a multi viewpoint sprite (multi-viewpoint resolution information), which depend on the viewing area priority information, are determined, images of respective viewpoints are selectively read out from a multi-resolution-level, a multi viewpoint image storage unit based on such multi-viewpoint resolution information to form a multi viewpoint sprite, and the multi viewpoint sprite is registered in a multi viewpoint sprite storage unit by appending a multi viewpoint sprite name to the multi viewpoint sprite.

[Arrangement of Apparatus]

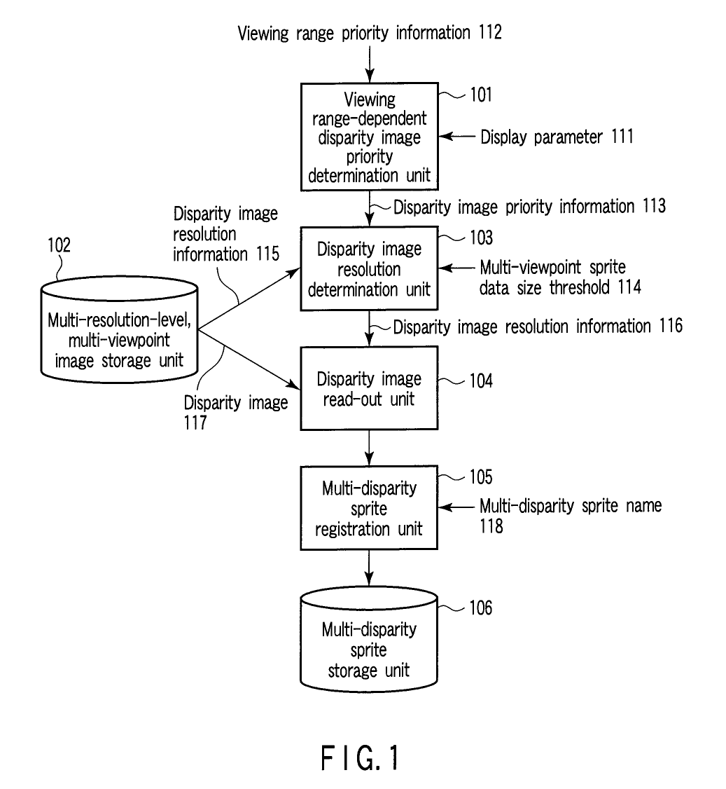

A multi parallax image generation apparatus of this embodiment will be described below with reference to FIG. 1.

The multi parallax image generation apparatus of the first embodiment includes a viewing area-dependent parallax image priority determination unit 101, multi-resolution-level, multi viewpoint image storage unit 102, parallax image resolution determination unit 103, parallax image read-out unit 104, multi viewpoint sprite registration unit 105, and multi viewpoint sprite storage unit 106.

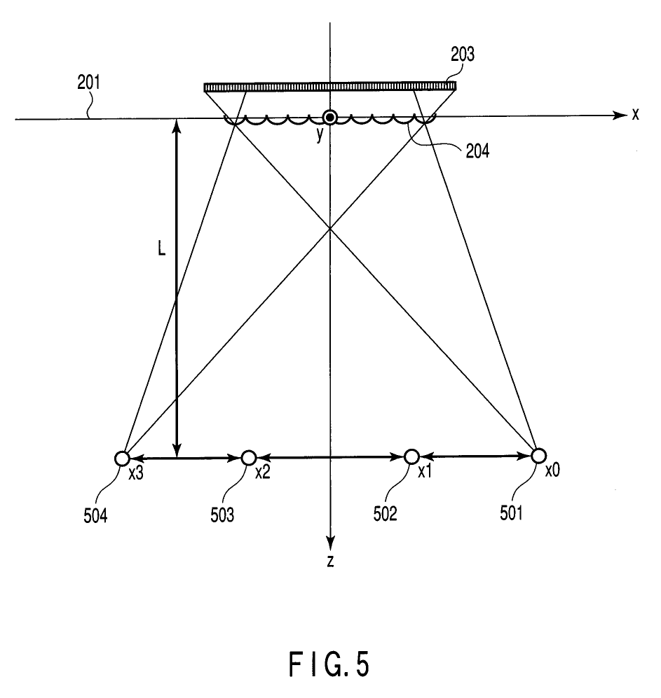

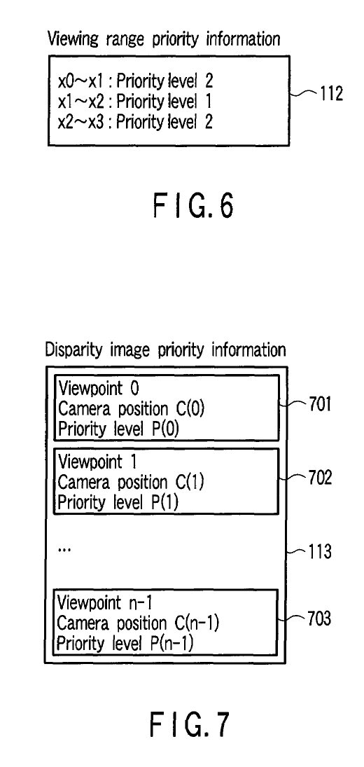

The viewing area-dependent parallax image priority determination unit 101 receives display parameters 111 of a 3D display and viewing area priority information 112 as inputs, and outputs parallax image priority information 113. More specifically, the viewing area-dependent parallax image priority determination unit 101 acquires the number of viewpoints and viewpoint positions from the display parameters, and generates parallax image priority information which specifies priority levels for respective viewpoints with reference to viewing area priority information given with priority levels in association with positions on a line having a predetermined viewing distance from the 3D display. The viewing area priority information 112 will be described later with reference to FIGS. 5 and 6. Details of the operation of the viewing area-dependent parallax image priority determination unit 101 will be described later with reference to FIG. 9.

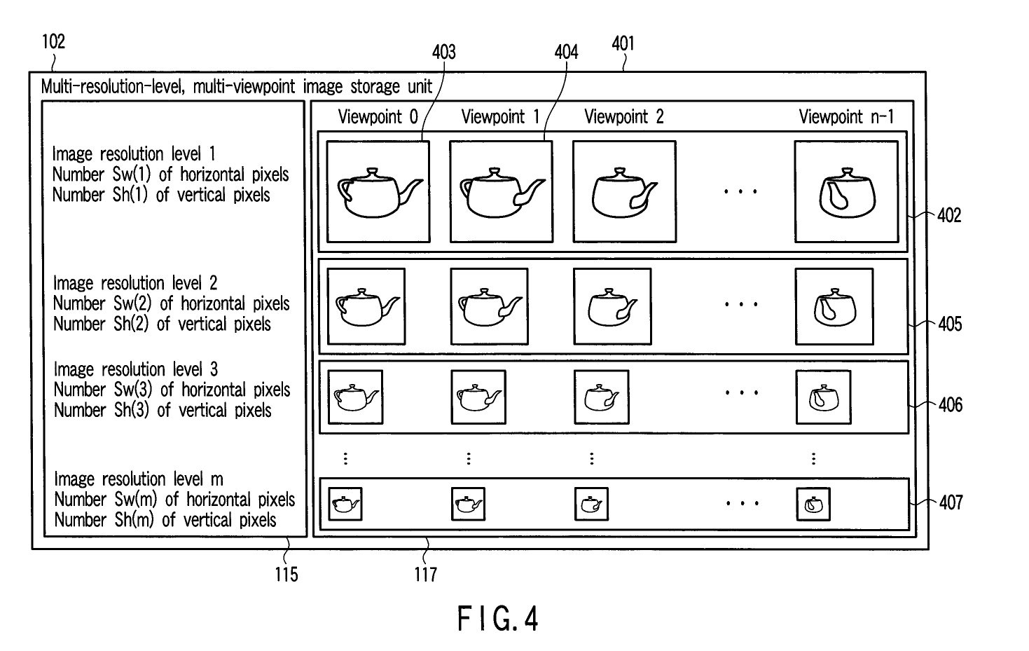

The multi-resolution-level, multi viewpoint image storage unit 102 stores images of a plurality of resolution levels in association with multi viewpoint images. The multi-resolution-level, multi viewpoint image storage unit 102 stores a plurality of parallax images at a plurality of viewpoints for a plurality of image resolution levels. The contents of the multi-resolution-level, multi viewpoint image storage unit 102 will be described later with reference to FIG. 4.

The parallax image resolution determination unit 103 receives the parallax image priority information 113 and a multi-viewpoint sprite data size threshold 114 as inputs, reads out parallax image resolution information 115 from the multi-resolution-level, multi viewpoint image storage unit 102, and outputs parallax image resolution information 116. The parallax image resolution determination unit 103 sets the image resolution levels for viewpoints to be rendered (for example, all viewpoints) to be a high-resolution level (e.g., highest level). When the sum total of the data sizes of parallax images of the viewpoints to be rendered is larger than the threshold, the unit 103 re-sets the image resolution levels of viewpoints with lower priority levels to be lower-resolution levels until the sum total becomes equal to or smaller than the threshold, generating parallax image resolution information, which specifies the image resolution levels of parallax images for the respective viewpoints. An example of the operation of the parallax image resolution determination unit 103 will be described later with reference to FIG. 11.

The parallax image read-out unit 104 receives the parallax image resolution information 116 as an input, and reads out parallax images 117 as many as the number of viewpoints from the multi-resolution-level, multi viewpoint image storage unit 102. The parallax image read-out unit 104 reads out parallax images corresponding to the resolution levels for respective viewpoints from the multi-resolution-level, multi viewpoint image storage unit 102.

The multi viewpoint sprite registration unit 105 receives a multi viewpoint sprite name 118 as an input, appends the multi viewpoint sprite name 118 to the parallax images as many as the number of viewpoints read out by the parallax image read-out unit 104, and records them in the multi viewpoint sprite storage unit 106.

The multi viewpoint sprite storage unit 106 stores the multi viewpoint sprite. The multi viewpoint sprite storage unit 106 stores the parallax images read out by the parallax image read-out unit 104 in association with the viewpoints.

[Viewing Area on 3D Display]

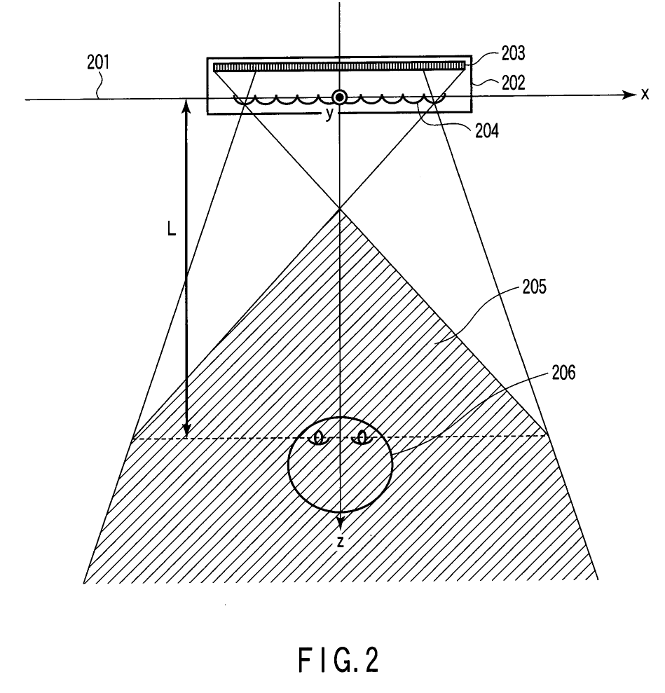

The positional relationship between a 3D display 202 and viewing area 205 of this embodiment will be described below with reference to FIG. 2. The 3D display 202 includes an LCD panel 203 and lenticular sheet 204.

The positional relationship between the 3D display 202 and a coordinate system 201 used in this embodiment will be described first. The 3D display 202 is laid out to face a viewer 206. Assume that the 3D display 202 is laid out so that the X-axis of the coordinate system 201 is parallel to the horizontal direction of the 3D display, the Y-axis of the coordinate system 201 is parallel to the vertical direction of the 3D display 202, and the origin of the 3D display 202 matches that of the coordinate system 201.

At this time, a hatched region in FIG. 2 corresponds to the viewing area 205 as a range where the viewer can appreciate an autostereoscopic image in association with the X-Z plane of the coordinate system 201. Note that L in FIG. 2 indicates a set viewing distance. This viewing area 205 can be calculated from the display parameters 111 that describe the specification of the 3D display. The set viewing distance L is also included in the display parameters. The calculation method of the viewing area 205 is described in, e.g., JP-A 2004-212666.

[Generation Processing of Multi Viewpoint Image]

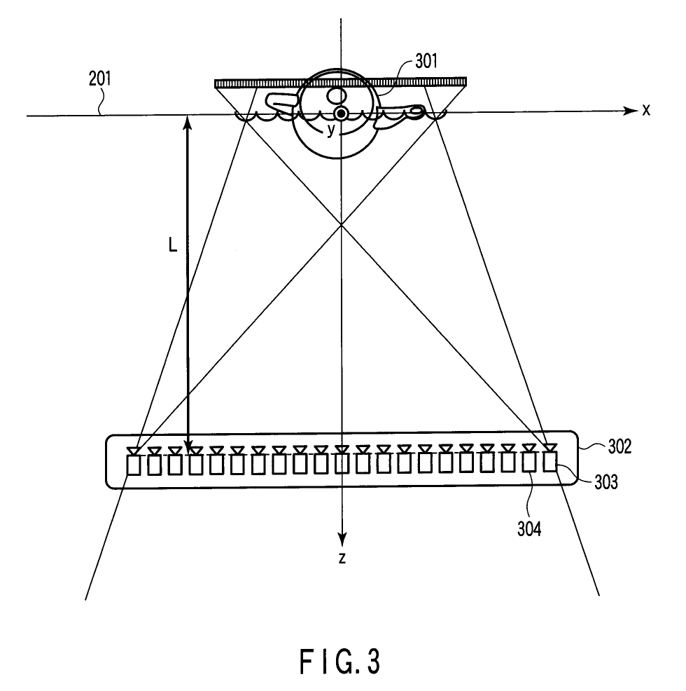

A method of creating a multi viewpoint image to be displayed on the 3D display will be described below with reference to FIG. 3.

As shown in FIG. 3, a CG object 301, a multi viewpoint image of which is to be generated, is arranged on the coordinate system 201 common to FIG. 2. Multi viewpoint cameras 302 are arranged at a constant interval on a line separated by the viewing distance L, and execute rendering processing or image capturing of the CG object 301. The method of calculating the positions of the multi viewpoint cameras 302 and the position interval between neighboring cameras is described in, e.g., JP-A 2007-96951. Images obtained by the respective multi viewpoint cameras 302 will be referred to as parallax images. A set of parallax images will be referred to as a multi viewpoint image.

In the parallax images obtained in this process, when an alpha component is expressed by 8 bits from 0 to 255, an alpha component that represents transparency of each pixel of a region where the CG object 301 is rendered is substituted with a value ranging from 1 to 255. On the other hand, in the parallax images, an alpha component that represents transparency of each pixel of a region where no CG object 301 is rendered but a background is rendered is substituted with a value “0”.

As a method of indicating a region where no object 301 is rendered in each parallax image, a method of defining a certain single color as a color indicating a region where no object is rendered in each parallax image (in this embodiment, this color is called a masking color), and using a color which is different from and similar to the masking color for each pixel of a region where the object is rendered without using the masking color is available in addition to the aforementioned method.

[Information Stored in Multi-Resolution-Level, Multi Viewpoint Image Storage Unit 102]

A multi viewpoint image created by executing the rendering processing by arranging the multi viewpoint cameras 302, as shown in FIG. 3, is stored in the multi-resolution-level, multi viewpoint image storage unit 102.

Information to be stored in the multi-resolution-level, multi viewpoint image storage unit 102 will be described below with reference to FIG. 4.

The multi-resolution-level, multi viewpoint image storage unit 102 stores the parallax image resolution information 115 and parallax images 117. In FIG. 4, reference numeral 401 denotes multi-resolution-level, multi viewpoint images corresponding to a certain CG object 301. Reference numeral 402 denotes a multi viewpoint image captured by the series of cameras shown in FIG. 3. For example, assume that an image 403 is captured by a rightmost camera 303 of the multi viewpoint cameras 302, and an image 404 is captured by a second rightmost camera 304.

Assume that the image resolution of the multi viewpoint image 402 is called “image resolution level 1”. Let Sw(1) be the number of horizontal pixels of each image of image resolution level 1, and Sh(1) be the number of vertical pixels.

The multi-resolution-level, multi viewpoint image storage unit 102 applies image reduction processing to respective images of the multi viewpoint image 402 to generate a multi viewpoint image 405, and that multi viewpoint image 405 will be referred to as a multi viewpoint image of “image resolution level 2”. Let Sw(2) be the number of horizontal pixels of each image of image resolution level 2, and Sh(2) be the number of vertical pixels. The image reduction processing in this case can use a general image processing tool or a mipmap filter of graphics hardware or the like. As generated by the mipmap filter, Sw(1):Sw(2)=Sh(1):Sh(2)=2:1, or other ratios may be used. The ratio between Sw(1) and Sw(2) and that between Sh(1) and Sh(2) need not always be the same.

By repeating such image reduction processing an arbitrary number of times, multi viewpoint images of a total of m image resolution levels from a multi viewpoint image 406 of “image resolution level 3” to a multi viewpoint image 407 of “image resolution level m” are further created. Multi-resolution-level, multi viewpoint images corresponding to the CG object 301 are created in this way.

A set of the numbers Sw of horizontal pixels and the numbers Sh of vertical pixels corresponding to the image resolution levels will be referred to as the parallax image resolution information 115 corresponding to a certain CG object 301.

Upon implementing this embodiment on a personal computer, the multi-resolution-level, multi viewpoint image storage unit 102 uses, for example, a main memory or an external storage device such as HDD or the like.

[Contents of Viewing Area Priority Information 112]

The contents of the viewing area priority information 112 will be described below with reference to FIGS. 5 and 6.

A viewing area priority level specifies a relative priority level between parallax images according to the positions of the cameras. In this embodiment, the resolution of a parallax image is set to be higher as priority is higher, and to be lower as priority is lower for respective viewpoint images of the multi viewpoint sprite.

FIG. 5 shows a setting example of viewing area priority levels. Points 501 to 504 on a line separated from the 3D display by the viewing distance L are defined. An X-coordinate component of the point 501 is defined as x0, and that of the point 502 is defined as x1 in turn up to an X-coordinate component x3 of the point 504. Assume that a region between the points 502 and 503 has a highest viewing area priority level, which is defined as “priority level 1”. A region between the points 501 and 502 and that between the points 503 and 504 have “priority level 2”, which is lower than “priority level 1”.

FIG. 6 shows the internal configuration of the viewing area priority information 112. This information describes the correspondence between the ranges of the X-coordinate components and priority levels corresponding to the aforementioned viewing area priority setting.

In this example, the viewing area priority includes two levels, i.e., “priority level 1” and “priority level 2”. However, the viewing area priority may include three or more priority levels. Also, the number of regions for which the priority levels are set is not limited to three, as shown in FIG. 6, but the priority levels may be defined for three or more regions, such as five regions.

For example, when the viewpoint position of the viewer is measured using a video camera or the like, and when the viewpoint position mainly exists on the right side of the horizontal center of the display, regions with higher viewing area priority levels may be defined as distributed on the right side of the viewing area. In this way, the distribution of the viewing area priority levels may be adaptively changed based on the positional relationship between the 3D display 202 and viewer 206.

[Contents of Parallax Image Priority Information 113]

The parallax image priority information 113 will be described below with reference to FIG. 7.

FIG. 7 shows the contents of the parallax image priority information 113 associated with a certain multi viewpoint sprite. The parallax image priority information 113 includes sets of multi viewpoint camera information and priority information. For example, a set 701 has a position C(0) of the camera 303, which captured an image at viewpoint 0, and a priority level P(0). Likewise, a set 702 corresponds to the camera 304, which captured an image at viewpoint 1.

In this way, the parallax image priority information 113 holds n pieces of parallax image priority information from viewpoints 0 to n−1. That is, different priority levels can be defined in association with respective viewpoint positions.

[Contents of Parallax Image Resolution Information 116]

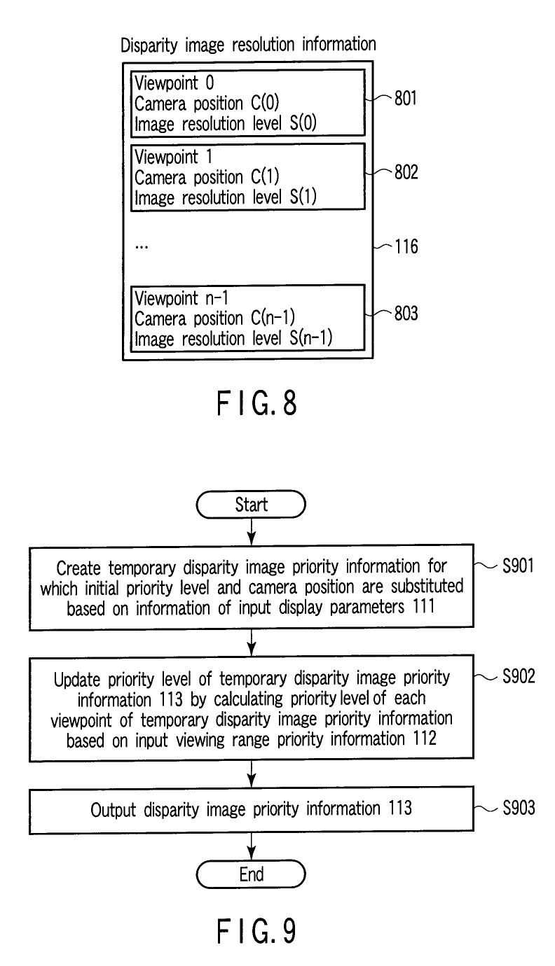

The parallax image resolution information 116 will be described below with reference to FIG. 8.

FIG. 8 shows the contents of the parallax image resolution information 116 in association with a certain multi viewpoint sprite. The parallax image resolution information 116 has sets of multi viewpoint camera position information and image resolution level information. For example, a set 801 holds a position C(0) of the camera 303 in FIG. 2, which captured an image at viewpoint 0, and image resolution level S(0) of that image. Likewise, a set 802 corresponds to the camera 304, which captured an image at viewpoint 1.

In this way, the parallax image resolution information 116 holds image resolution level information of n parallax images from viewpoints 0 to n−1. That is, the user can designate to display images of different resolutions for respective viewpoint positions.

[Processing Contents of Viewing Area-Dependent Parallax Image Priority Determination Unit 101]

An example of the processing sequence of the viewing area-dependent parallax image priority determination unit 101 will be described below with reference to FIG. 9. Upon practicing this embodiment on a personal computer, the viewing area-dependent parallax image priority determination unit 101 is a program implemented on a CPU.

(Step S901) The viewing area-dependent parallax image priority determination unit 101 creates temporary parallax image priority information for which an initial value (initial priority level) is substituted based on information of the input display parameters 111. The unit 101 acquires the number n of viewpoints from the display parameters 111, and assures storage areas as many as the number n of viewpoints of the temporary parallax image priority information. The unit 101 acquires the positions of the respective multi viewpoint cameras 302 from the display parameters 111, and substitutes them for camera positions C(0) to C(n−1) of the viewpoints of the temporary parallax image priority information. The unit 101 then substitutes a value “priority level 1” indicating the highest priority for priority levels P(0) to P(n−1) of the respective viewpoints of the temporary parallax image priority information.

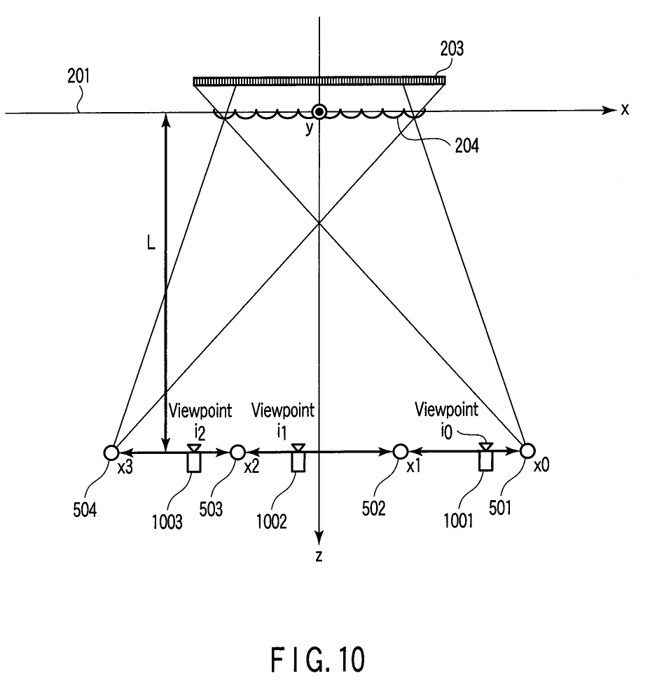

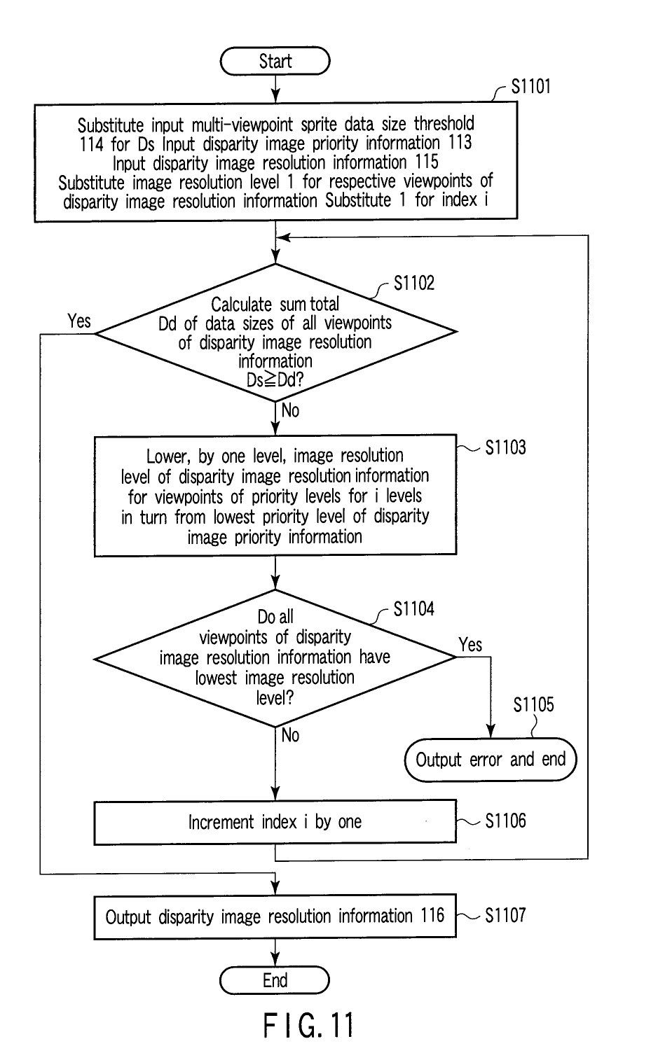

(Step S902) The viewing area-dependent parallax image priority determination unit 101 calculates priority levels of the respective viewpoints of the temporary parallax image priority information based on the input viewing area priority information 112. The detailed processing contents will be given below with reference to FIG. 10.

In the example of FIG. 10, a camera 1001 corresponding to a viewpoint i0 exists between the points x0 and x1. Since it is determined based on the viewing area priority information 112 that the region between the points x0 and x1 has “priority level 2”, “priority level 2” is substituted for a priority level P(i0) of the parallax image priority information 113 corresponding to the viewpoint i0. Likewise, a camera 1002 corresponding to a viewpoint i1 exists between the points x1 and x2, and this region has “priority level 1”. Hence, “priority level 1” is substituted for a priority level P(i1). Furthermore, since a camera 1003 corresponding to a viewpoint i2 exists between the points x2 and x3, and this region has “priority level 2”, “priority level 2” is substituted for a priority level P(i2). This processing is repeated for respective viewpoints to be rendered.

(Step S903) The viewing area-dependent parallax image priority determination unit 101 outputs the parallax image priority information 113 obtained by the processing in step S902, thus ending the processing.

[Processing Contents of Parallax Image Resolution Determination Unit 103]

An example of the processing sequence of the parallax image resolution determination unit 103 will be described below with reference to FIG. 11. Upon practicing this embodiment on a personal computer, the parallax image resolution determination unit 103 is a program implemented on a CPU.

(Step S1101) The parallax image resolution determination unit 103 substitutes the input multi-viewpoint sprite data size threshold 114 for a variable Ds. Likewise, the unit 103 receives the parallax image priority information 113 and parallax image resolution information 115. The contents of the parallax image priority information 113 are shown in detail in FIG. 7, and those of the parallax image resolution information 116 are shown in FIG. 8. The unit 103 substitutes the resolution of image resolution level 1 as the highest resolution information in association with the respective viewpoints of the parallax image resolution information. Finally, the unit 103 substitutes “1” for an index i used in the subsequent loop.

(Step S1102) The parallax image resolution determination unit 103 calculates a sum total Dd of parallax image data sizes of all the viewpoints of the parallax image resolution information 116. Dd is calculated by:

$$Dd = {\sum }_{k = 0}^{n - 1} Sw ( S ( k ) ) \cdot Sh ( S ( k ) ) \cdot BPP$$

where Sw(k) and Sh(k) are values to be referred to from the parallax image resolution information 115. Also, S(k) is an image resolution level of each viewpoint image in the parallax image resolution information 116. BPP is a coefficient indicating an information size per pixel. If a unit of Dd is “byte”, each pixel has four color elements, R, G, B, and A, and each element is defined by 8 bits (1 byte), BPP=4.

The parallax image resolution determination unit 103 compares the calculated Dd with Ds input in step S1101. If Ds≧Dd, the process jumps to step S1107. If Ds<Dd, the process advances to step S1103.

(Step S1103) The parallax image resolution determination unit 103 lowers by one level the image resolution levels of the corresponding parallax image resolution information 116 in association with viewpoints for i priority levels in turn from the lowest priority level of the parallax image priority information 113. Lowering by one level means as follows. That is, when S(j)<m (m is the lowest image resolution level in the parallax image resolution information 115) in association with certain viewpoint j, “1” is added to S(j).

This processing will be described in detail below.

For example, assume that index i is “1”, and priority levels of the respective viewpoints of the parallax image priority information 113 are comprised of two priority levels, i.e., “priority level 1” and “priority level 2”. The lowest one of the plurality of priority levels is “priority level 2”, and the priority level for one level from lowest “priority level 2” is “priority level 2”. Therefore, if a certain viewpoint j of “priority level 2” has image resolution level S(j), which is less than lowest image resolution level m, “1” is added to S(j).

An example under different conditions will be described below. Assume that index i is “2”, and priority levels of the respective viewpoints of the parallax image priority information 113 are similarly comprised of two priority levels, i.e., “priority level 1” and “priority level 2”. The lowest one of the plurality of priority levels is “priority level 2”, and the priority level for two levels from lowest “priority level 2” corresponds to “priority level 1” and “priority level 2”. Therefore, if a certain viewpoint j of “priority level 1” or “priority level 2” has image resolution level S(j), which is less than lowest image resolution level m, “1” is added to S(j).

(Step S1104) The parallax image resolution determination unit 103 checks if the viewpoints to be rendered of the parallax image resolution information 116 have the lowest image resolution level. More specifically, the unit 103 checks if S(j)=m for viewpoint j to be rendered. If this condition is met, it is impossible to generate sprite data which satisfies the multi-viewpoint sprite data size threshold Ds even when the resolution is lowered any more. For this reason, the process advances to step S1105, thus ending the processing after an error is output (step S1105).

If the condition is not met in step S1104, the process advances to step S1106.

The parallax image resolution determination unit 103 increments the index i by one, and the process returns to step S1102 (step S1106). The unit 103 outputs the parallax image resolution information 116, thus ending the processing (step S1107).

[Processing Contents of Parallax Image Read-Out Unit 104]

The parallax image read-out unit 104 reads out parallax images of corresponding resolutions for the respective viewpoints from the multi-resolution-level, multi viewpoint image storage unit 102 based on the input parallax image resolution information 116. The configuration of the parallax image resolution information 116 is shown in detail in FIG. 8. For example, when the resolution of viewpoint 0 is designated as image resolution level 2, as indicated by the set 801 in FIG. 8, the unit 104 reads out an image of viewpoint 0 having image resolution level 2 from the multi-resolution-level, multi viewpoint image storage unit 102 as a sprite image of viewpoint 0. The unit 104 repeats the aforementioned processing for the number of viewpoints.

The parallax image read-out unit 104 outputs a readout multi viewpoint sprite image. Upon practicing this embodiment on a personal computer, the parallax image read-out unit 104 is a program implemented on a CPU.

[Information Stored in Multi Viewpoint Sprite Storage Unit 106]

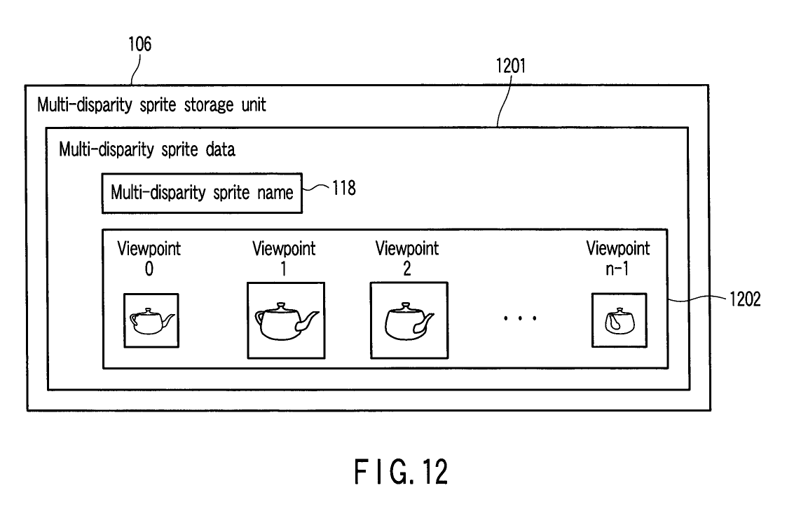

FIG. 12 shows multi viewpoint sprite information stored in the multi viewpoint sprite storage unit 106. Upon practicing this embodiment on a personal computer, the multi viewpoint sprite storage unit 106 uses, for example, a main memory or an external storage device such as an HDD or the like.

The multi viewpoint sprite storage unit 106 associates the multi viewpoint sprite name 118 with a multi viewpoint sprite image 1202 and holds that image as multi viewpoint sprite data 1201. Assume that the multi viewpoint sprite storage unit 106 can store a plurality of multi viewpoint sprite data 1201, and distinguishes these multi viewpoint sprites using the multi viewpoint sprite names 118. As the multi viewpoint sprite names, for example, serial numbers, character strings, and the like are used.

[Processing Contents of Multi Viewpoint Sprite Registration Unit 105]

The multi viewpoint sprite registration unit 105 receives the multi viewpoint sprite image as an output of the parallax image read-out unit 104, and the multi viewpoint sprite name 118. The multi viewpoint sprite registration unit 105 forms the multi viewpoint sprite data 1201 by associating the multi viewpoint sprite name 118 in FIG. 12 with the input multi viewpoint sprite image 1202, and registers it in the multi viewpoint sprite storage unit 106.

Upon practicing this embodiment on a personal computer, the multi viewpoint sprite registration unit 105 is a program implemented on a CPU.

### Effect of First Embodiment

This embodiment generates multi viewpoint sprite data by reading out a multi-resolution-level, multi viewpoint sprite, which is defined to have different resolutions for the respective viewpoints, from the multi-resolution-level, multi viewpoint image storage unit based on the parallax image priority information defined based on the viewing area of the 3D display, and the given multi viewpoint sprite data size threshold.

When sprite images of viewpoints to be rendered are to be held at a high resolution, and when the multi viewpoint sprite data size exceeds the multi viewpoint sprite data size threshold, the multi parallax image generation apparatus of the first embodiment can be used to configure a multi viewpoint sprite within a data size that does not exceed the multi viewpoint sprite data size threshold without visually considerably deteriorating a screen image of the sprite when the viewpoint of the viewer exists at the center of the viewing area at high frequencies, in such a manner that a sprite image of a high resolution is selected for a viewpoint with a high viewing area priority level and a sprite image of a low resolution is selected for a viewpoint with a low viewing area priority level.

Note that this embodiment may be practiced in pre-processing of execution of a 3D display application using a multi viewpoint sprite.

The first embodiment is targeted at the 3D display which generates a parallax only in the horizontal direction, and configures a multi-resolution-level, multi viewpoint sprite for one dimension in the horizontal direction. However, this embodiment can be practiced for a 3D display which generates disparities in the horizontal and vertical directions by applying the contents of this embodiment to two dimensions, i.e., the vertical and horizontal directions.

### Second Embodiment

This embodiment will exemplify a case in which a multi viewpoint sprite is read out from a multi viewpoint sprite storage unit, and is rendered at the designated position so as to present the multi viewpoint sprite as an autostereoscopic image, in addition to the arrangement of the first embodiment.

[Arrangement of Apparatus]

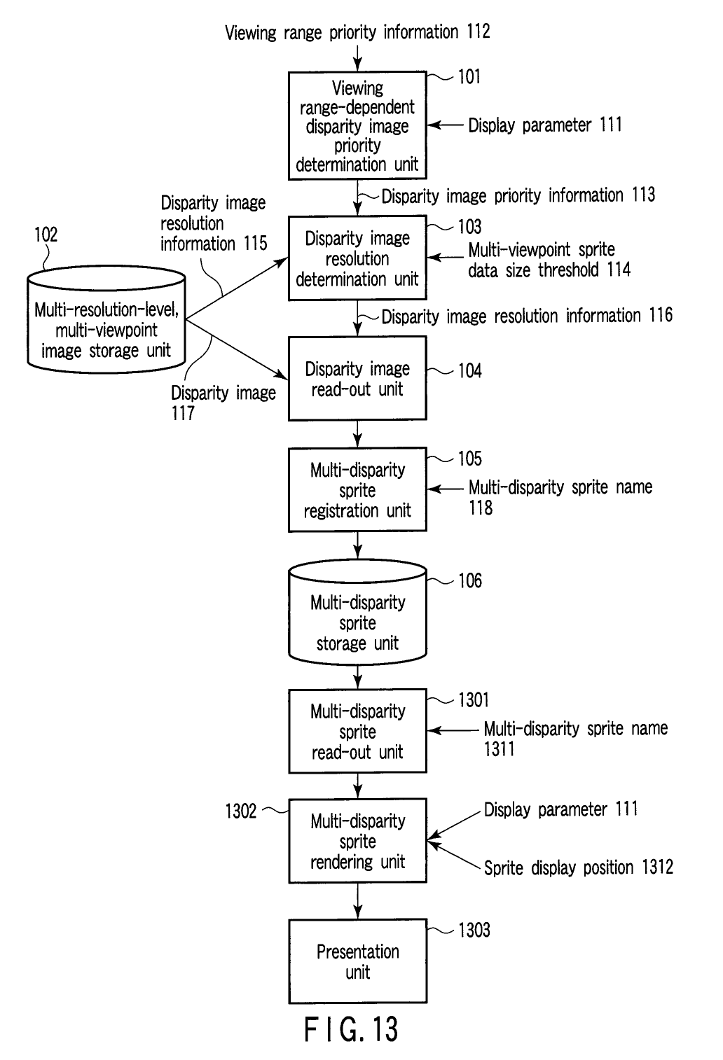

A multi parallax image generation apparatus of this embodiment will be described below with reference to FIG. 13.

The multi parallax image generation apparatus of the second embodiment includes a multi viewpoint sprite read-out unit 1301, multi viewpoint sprite rendering unit 1302, and presentation unit 1303 in addition to the multi parallax image generation apparatus of the first embodiment shown in FIG. 1.

The multi viewpoint sprite read-out unit 1301 reads out multi viewpoint sprite data from a multi viewpoint sprite storage unit 106 to have a multi viewpoint sprite name 1311 as an input.

The multi viewpoint sprite rendering unit 1302 renders the readout multi viewpoint sprite on a frame memory based on display parameters 111 and sprite display positions 1312.

The presentation unit 1303 presents the multi viewpoint sprite rendered on the frame memory as an autostereoscopic image.

[Processing Contents of Multi Viewpoint Sprite Read-Out Unit 1301]

The multi viewpoint sprite read-out unit 1301 reads out multi viewpoint sprite data corresponding to the input multi viewpoint sprite name 1311 from the multi viewpoint sprite storage unit 106. The readout multi viewpoint sprite data is input to the multi viewpoint sprite rendering unit 1302. Upon practicing this embodiment on a personal computer, the multi viewpoint sprite read-out unit 1301 is a program implemented on a CPU, and executes processing for transferring a multi viewpoint sprite to a video memory of graphics hardware installed with the multi viewpoint sprite rendering unit 1302.

[Processing Contents of Multi Viewpoint Sprite Rendering Unit 1302]

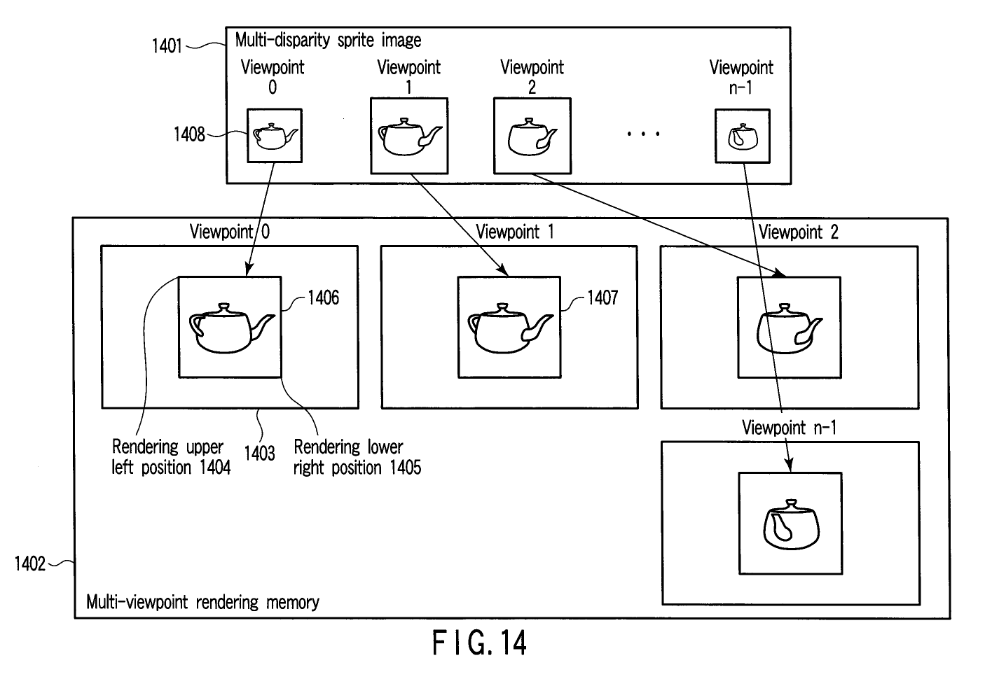

The processing contents of the multi viewpoint sprite rendering unit 1302 will be described below with reference to FIG. 14. The multi viewpoint sprite rendering unit 1302 transfers a multi viewpoint sprite image 1401 read out by the multi viewpoint sprite read-out unit 1301 onto a multi-viewpoint rendering frame memory 1402 based on the input display parameters 111 and sprite display positions 1312.

The input display parameters 111 hold the number of multi-viewpoint rendering frame memories, the number of pixels of a frame memory of each viewpoint, and parameters required upon displaying the contents of the multi-viewpoint rendering frame memory on the presentation unit 1303. The display parameters 111 input to the multi viewpoint sprite rendering unit 1302 need to be the same as those substituted in a viewing area-dependent parallax image priority determination unit 101. Please refer to, for example, JP-A 2007-96951 for the practical contents of the display parameters.

The multi viewpoint sprite image 1401 includes sprite images 1408 of different resolutions for n viewpoints and the like. The multi-viewpoint rendering frame memory 1402 includes frame buffers 1403 for n viewpoints, and the like. For example, as for viewpoint 0, an image is transferred from the sprite image 1408 to a multi viewpoint sprite rendering area 1406 designated by sprite display positions 1404 and 1405 on the frame buffer 1403. This processing is repeated for n viewpoints to be rendered. When the rendering upper left position 1404 is set to be the same as the rendering lower right position 1405 for each viewpoint, a multi viewpoint sprite is displayed to exist on the 3D display panel surface. When sprite images are rendered at different positions for respective viewpoints so as to provide disparities for the respective viewpoints, a multi viewpoint sprite is displayed to exist in front of or at the back of the 3D display panel surface. Please refer to, for example, JP-A 2007-96951 for the practical contents of this processing.

Since the multi viewpoint sprite rendering area 1406 of viewpoint 0 and a multi viewpoint sprite rendering area 1407 of viewpoint 1 store images of an identical object from different positions, the transfer destination areas have a common size. Therefore, the images on the multi viewpoint sprite image 1401 undergo enlargement or reduction processing to match the sizes of the rendering areas of the respective viewpoints on the multi-viewpoint rendering frame memory 1402.

Upon practicing this embodiment on a personal computer, the multi viewpoint sprite rendering unit 1302 is processing implemented on graphics hardware mounted in the personal computer. More specifically, the multi viewpoint sprite image 1401 is held on a video memory of graphics hardware as texture mapping data. The multi-viewpoint rendering frame memory 1402 is held on the video memory of graphics hardware as frame buffers. Transfer processing from the multi viewpoint sprite image 1401 to the multi-viewpoint rendering frame memory 1402 is executed by texture mapping processing to polygons in graphics hardware. The transfer processing will be described in detail below. For example, in the case of viewpoint 0, the sprite image 1408 is prepared as a texture map. Then, the texture coordinates of four corners of the sprite image 1408 are substituted in those of vertices of four corners of a rectangular polygon corresponding to the rendering area 1406. In the rendering processing on the frame buffer 1403, the rectangular polygon defined by the rendering upper left position 1404 and rendering lower right position 1405 is rendered. This processing is repeated for viewpoints to be rendered.

[Processing Contents of Presentation Unit 1303]

The presentation unit 1303 outputs the contents of the multi-viewpoint rendering frame memory 1402 rendered by the multi viewpoint sprite rendering unit 1302 to a 3D display.

### Effect of Second Embodiment

This embodiment generates multi viewpoint sprite data by reading out a multi-resolution-level, multi viewpoint sprite, which is defined to have different resolutions for respective viewpoints, from the multi-resolution-level, multi viewpoint image storage unit based on the parallax image priority information defined based on the viewing area of the 3D display, and the given multi viewpoint sprite data size threshold, and presents the generated multi viewpoint sprite at an arbitrary position on the 3D display.

When sprite images of viewpoints to be rendered are to be held at a high resolution, and when the multi viewpoint sprite data size exceeds the multi viewpoint sprite data size threshold, the multi parallax image generation apparatus of the second embodiment can be used to configure a multi viewpoint sprite within a data size that does not exceed the multi viewpoint sprite data size threshold and can display it on the 3D display without visually considerably deteriorating a screen image of the sprite when the viewpoint of the viewer exists at the center of the viewing area at high frequencies, in such a manner that a sprite image of a high resolution is selected for a viewpoint with a high viewing area priority level and a sprite image of a low resolution is selected for a viewpoint with a low viewing area priority level.

Upon practicing this embodiment on a personal computer, the multi viewpoint sprite image 1401 in the multi viewpoint sprite rendering unit 1302 is stored in the video memory. Since the occupied video memory size per multi viewpoint sprite is reduced according to this embodiment, the video memory can store many types of multi viewpoint sprites compared to a case in which sprite images of viewpoints to be rendered are held at a high resolution.

In terms of limitations on the data transfer rate of the video memory, by reducing the occupied video memory size per multi viewpoint sprite, a time required per multi viewpoint sprite for data transfer from a texture memory to the frame buffer is reduced compared to a case in which sprite images of viewpoints to be rendered are held at a high resolution. As a result, a time required to render the multi viewpoint sprite can be shortened, and the processing of an application using the multi viewpoint sprite can be speeded up.

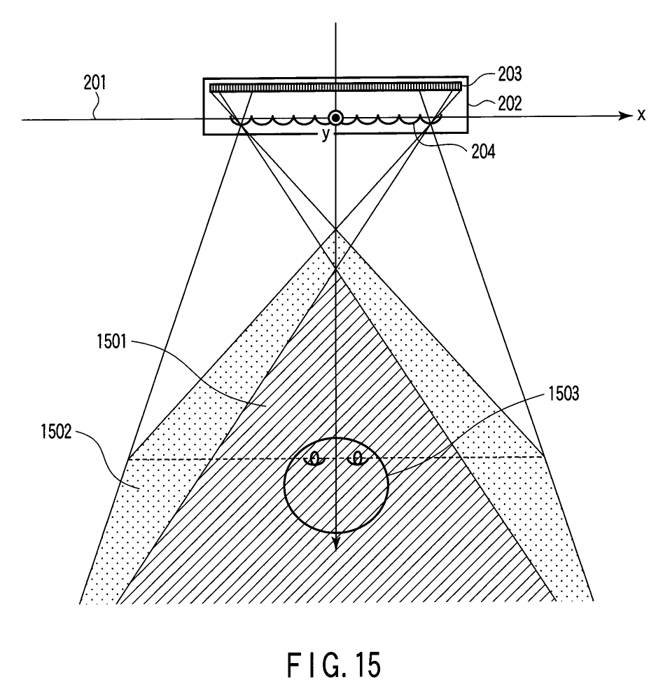

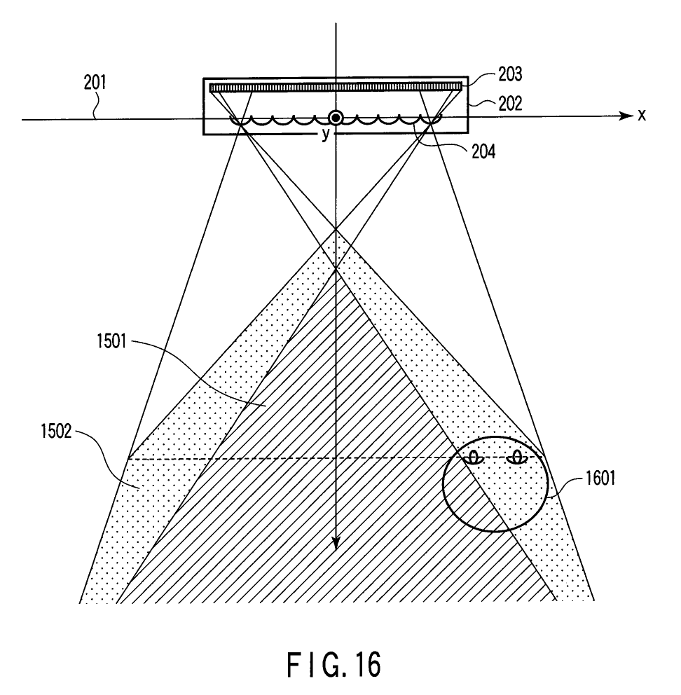

Subsidiary effects will be described below with reference to FIGS. 15 and 16. Assume that according to this embodiment, the image resolution of a multi viewpoint sprite observed near the center (hatched portion 1501) of the viewing area of the 3D display is set to be high, while that of the multi viewpoint sprite observed near the boundaries (dotted portion 1502) of the viewing area is set to be low. When the viewpoint of the viewer exists near the center of the viewing area, as denoted by reference numeral 1503 in FIG. 15, he or she perceives the multi viewpoint sprite to have a high resolution. However, when the viewpoint of the viewer approaches the viewing area boundary, as denoted by reference numeral 1601 in FIG. 16, he or she perceives the multi viewpoint sprite to have a low resolution. With this effect, the viewer can perceive that the current viewpoint position is close to the viewing area boundary.

When the viewpoint position of the viewer moves outside the viewing area boundary, the viewer unwantedly perceives an abnormal autostereoscopic image, thus posing a problem. Using the multi viewpoint sprite generated by this embodiment, the viewing area where an autostereoscopic image is normally observed is presented as a change in image resolution of the multi viewpoint sprite to be observed, thus preventing this problem.

This embodiment may be practiced in pre-processing of that of a 3D display application using a multi viewpoint sprite. By applying this embodiment to scene graph processing means in the 3D display application (a scene graph means a spatial data structure of a CG object), the configuration of a multi viewpoint sprite can be dynamically changed in accordance with the state of the application such as a video memory consumption amount of graphics hardware and the like during execution of the application.

This embodiment is targeted at the 3D display which generates a parallax only in the horizontal direction, and configures a multi-resolution-level, multi viewpoint sprite for one dimension in the horizontal direction. However, this embodiment can be practiced for a 3D display which generates disparities in the horizontal and vertical directions by applying the contents of this embodiment to two dimensions, i.e., in the vertical and horizontal directions.

### Third Embodiment

This embodiment will exemplify an apparatus, which receives sprite display position information in a screen and display parameters as inputs, determines resolutions for respective viewpoints of a multi viewpoint sprite depending on the sprite display position information, configures a multi viewpoint sprite by selectively reading out images of the respective viewpoints from a multi-resolution-level, multi viewpoint image storage unit 102 based on that multi-viewpoint resolution information, and registers the multi viewpoint sprite in a multi viewpoint sprite storage unit by appending a multi viewpoint sprite name to it.

[Arrangement of Apparatus]

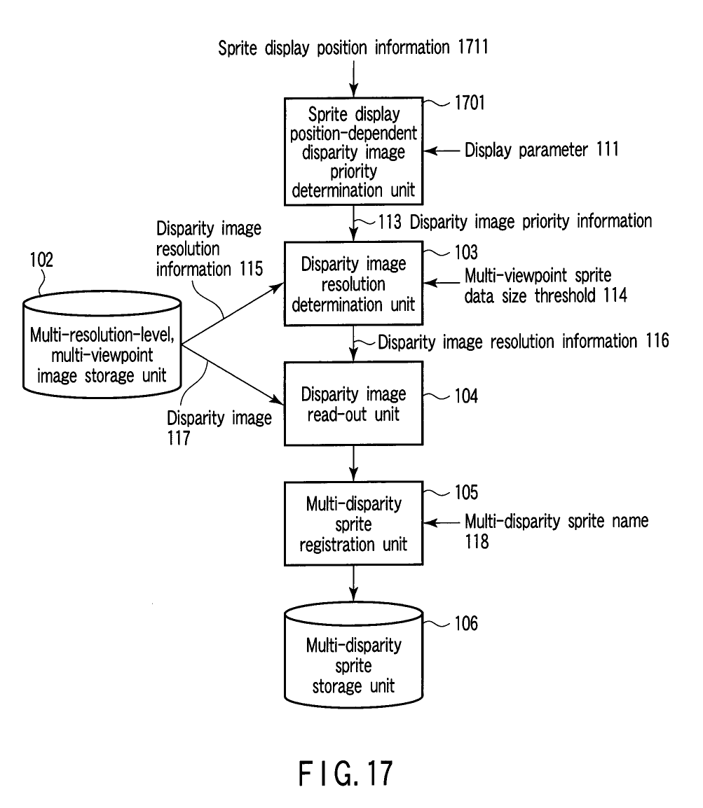

A multi parallax image generation apparatus of this embodiment will be described below with reference to FIG. 17.

The multi parallax image generation apparatus of the third embodiment includes a sprite display position-dependent parallax image priority determination unit 1701 in place of the viewing area-dependent parallax image priority determination unit 101 of the first embodiment, and other units are the same as those in the first embodiment.

The sprite display position-dependent parallax image priority determination unit 1701 receives display parameters 111 of a 3D display and sprite display position information 1711 as inputs, and outputs parallax image priority information 113. The sprite display position-dependent parallax image priority determination unit 1701 acquires the number of viewpoints and positions of the viewpoints from the display parameters, and accumulates frequencies of location of parallax images for respective positions with reference to display position information indicating the display positions of parallax images in association with times, thereby generating parallax image priority information that defines priority levels according to the frequencies for the respective viewpoints.

Differences between this embodiment and the first embodiment will be described below.

[Configuration of Sprite Display Position Information 1711]

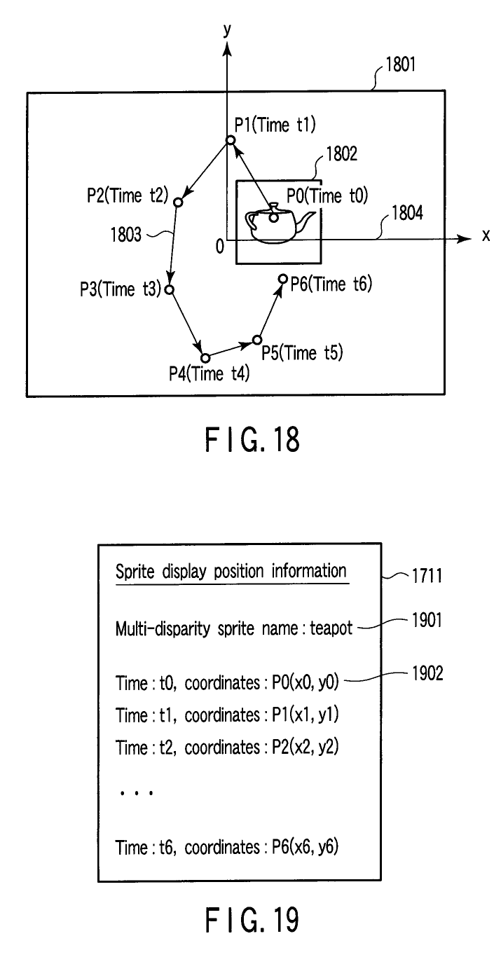

The sprite display position information 1711 will be described below with reference to FIGS. 18 and 19.

Practical contents of the sprite display position information 1711 include information defined in FIG. 19.

FIG. 18 shows an example that illustrates a change over time in display position of a multi viewpoint sprite. In a screen 1801 of the 3D display, a path of the central position of a multi viewpoint sprite 1802 is indicated by a set 1803 of directed line segments. Assume that the multi viewpoint sprite has parallax images of n viewpoints, and one representative parallax image 1802 (e.g., a parallax image at the central viewpoint) is used in this case. Reference numeral 1804 denotes a coordinate system of the screen 1801. In this embodiment, the center of the screen is defined as an origin, a rightward horizontal direction is defined as an x-axis positive direction, and an upward vertical direction is defined as a y-axis positive direction. The screen coordinate system 1804 can be arbitrarily changed depending on the form of a display system.

Note that the path 1803 will be referred to as a motion path of the multi viewpoint sprite. The motion path in this embodiment is a polygonal line defined by points P0, P1, . . . , P6 on the screen. The central position of the multi viewpoint sprite 1802 is located on the point P0 at time t0, and on the point P1 at time t1. At time t (t0≦t≦t1), a central position P is located at a position which is obtained by internally dividing P0 and P1 and is defined by:

$$P = P 0 \frac{t 1 - t}{t 1 - t 0} + P 1 \frac{t - t 0}{t 1 - t 0}$$

The same applies to a time range t1≦t. In this way, the multi viewpoint sprite 1802 moves along this polygonal line 1803.

FIG. 19 shows the configuration of the sprite display position information 1711 corresponding to the path of the multi viewpoint sprite shown in FIG. 18. The sprite display position information 1711 includes a multi viewpoint sprite name 1901, and information 1902, which defines the central positions of the multi viewpoint sprite in association with times in turn. Assume that coordinates P0, P1, . . . , P6 are defined by two-dimensional coordinates.

In the third embodiment, the motion path is defined by a polygonal line. Alternatively, the motion path may be defined by a curve using a Bezier function, spline function, or the like.

In the third embodiment, the multi viewpoint sprite two-dimensionally moves on the screen surface. Alternatively, the motion path may be defined so that the multi viewpoint sprite moves three-dimensionally as well as the depth direction of the 3D display. In this case, projection processing from three dimensions into two dimensions (e.g., information of the depth direction as a Z-component of the coordinates is not used) needs to be executed.

[Processing Contents of Sprite Display Position-Dependent Parallax Image Priority Determination Unit 1701]

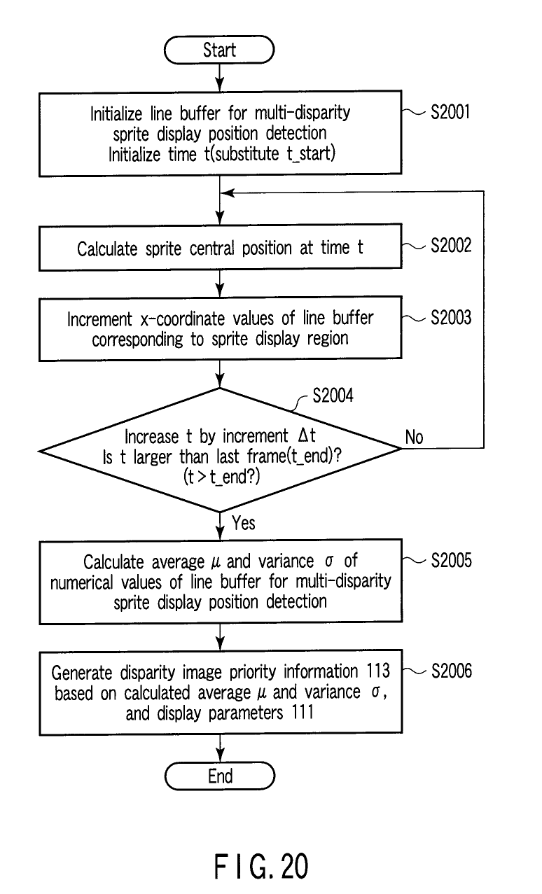

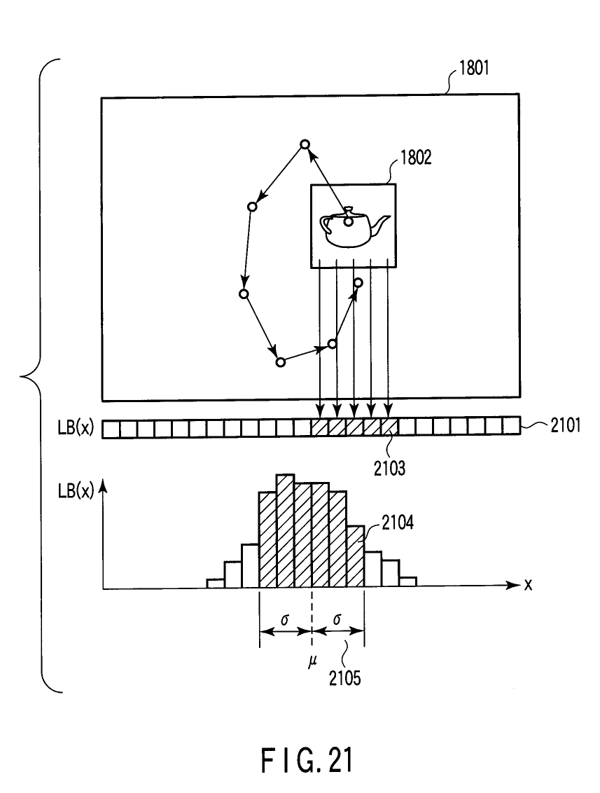

An example of the processing contents of the sprite display position-dependent parallax image priority determination unit 1701 will be described below with reference to FIGS. 20 and 21. FIG. 20 is a flowchart showing processing of the sprite display position-dependent parallax image priority determination unit 1701. Upon practicing this embodiment on a personal computer, the sprite display position-dependent parallax image priority determination unit 1701 is a program implemented on a CPU.

(Step S2001) The sprite display position-dependent parallax image priority determination unit 1701 initializes a multi viewpoint sprite display position detection line buffer. This line buffer is denoted by reference numeral 2101 in FIG. 21, and stores numerical values as many as the number of horizontal pixels of the screen 1801 of the 3D display. In this case, the unit 1701 substitutes all “0”s for a line buffer LB(x). The unit 1701 substitutes t_start as a start time of the motion path for a variable t that stores a time. In the motion path 1803 in FIG. 18, t_start=t0.

(Step S2002) The sprite display position-dependent parallax image priority determination unit 1701 calculates the sprite central position at current time t with reference to the sprite display position information shown in FIG. 19. The calculation method of the central position uses that described in the configuration of the sprite display position information 1711.

(Step S2003) The sprite display position-dependent parallax image priority determination unit 1701 increments x-coordinate values of the line buffer corresponding to the sprite display region. More specifically, the unit 1701 increments by one the values of the line buffer within a range between a minimum x-coordinate value x_min and maximum x-coordinate value x_max of non-transparent effective pixels in the sprite image like:

For x within a range x_min≦x≦x_max, LB(x)=LB(x)+1

FIG. 21 illustrates the aforementioned processing. In FIG. 21, reference numeral 2103 denote effective pixels in the horizontal direction in the sprite image, and the values of the line buffer 2101 in this region are incremented by one.

In this embodiment, the enlargement or reduction processing upon displaying a multi viewpoint sprite is not executed. When the enlargement or reduction processing upon displaying a multi viewpoint sprite is executed, the sprite display region 1802 is enlarged or reduced, and that result is reflected in the line buffer 2103.

(Step S2004) The sprite display position-dependent parallax image priority determination unit 1701 increases the time variable t by a predetermined increment Δt of time. Assume that the increment Δt is set according to the moving speed of the multi viewpoint sprite. If t assumes a value larger than an end time t_end of the motion path, the process advances to step S2005. If the time variable t is smaller than t_end, the process returns to step S2002.

(Step S2005) The sprite display position-dependent parallax image priority determination unit 1701 calculates an average μ and variance σ of the numerical values of the line buffer LB(x). In FIG. 21, reference numeral 2104 denotes a histogram which indicates the values of the line buffer. In an x-coordinate region where the multi viewpoint sprite exists at high frequencies, the values of the histogram 2104 become large. From this histogram, the unit 1701 calculates the average μ and variance σ, which are denoted by reference numeral 2105. Of the histogram 2104, a hatched region corresponds to a region that meets μ−σ≦x≦μ+σ, and the multi viewpoint sprite is displayed at higher frequencies in statistics in association with the horizontal direction. In this embodiment, this region will be referred to as a multi viewpoint sprite high-frequency display range.

(Step S2006) The sprite display position-dependent parallax image priority determination unit 1701 generates and outputs parallax image priority information 113 based on the calculated average μ and variance σ, and the display parameters 111. The practical contents of this processing will be described below.

[Generation Processing of Parallax Image Priority Information 113 in Sprite Display Position-Dependent Parallax Image Priority Determination Unit 1701]

The generation processing of the parallax image priority information 113 in the sprite display position-dependent parallax image priority determination unit 1701 will be described in detail below.

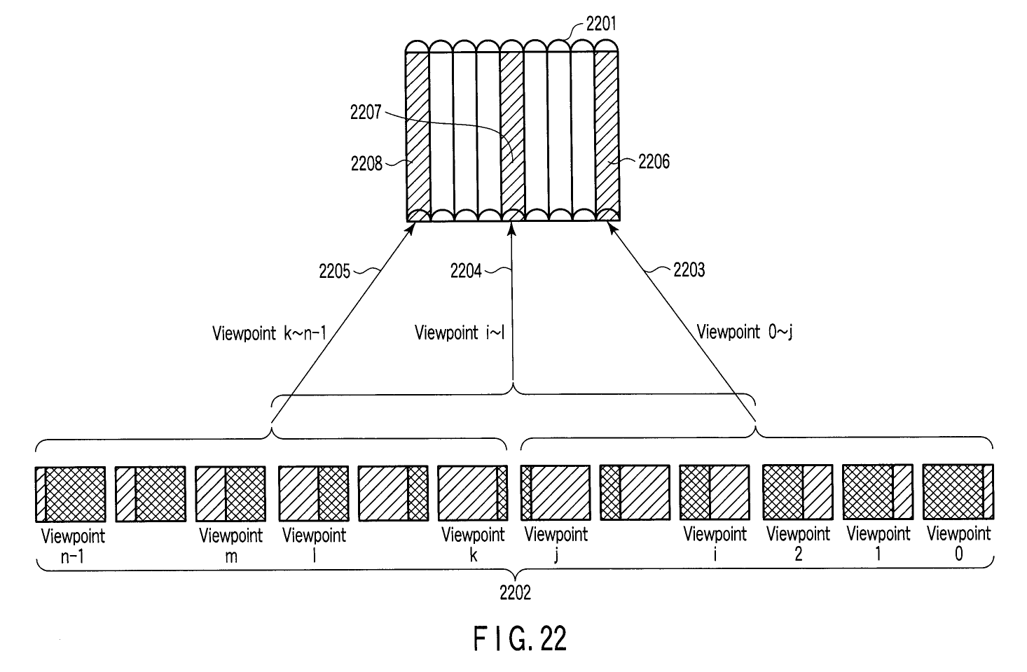

As described in JP-A 2004-212666, the 3D display of this embodiment enlarges the viewing area using a viewing area optimization method. This method is implemented as follows. That is, as shown in FIG. 22, a rendering unit generates multi viewpoint images 2202 for viewpoints (e.g., 24 viewpoints) larger than the number of viewpoints (e.g., 12 viewpoints) realized by a lenticular lens for one pixel of a 3D display 2201, so that pixels in the horizontal direction of the 3D display are associated with viewpoint images of different combinations. For example, a certain pixel 2206 of the 3D display 2201 uses multi viewpoint images 2203 from viewpoint 0 to viewpoint j of the multi viewpoint image 2202 in display. Likewise, a pixel 2207 uses multi viewpoint images 2204 from viewpoint i to viewpoint 1 in display, and a pixel 2208 uses multi viewpoint images 2205 from viewpoint k to viewpoint n−1 in display. That is, not all the regions of the multi viewpoint images 2202 are displayed as pixels of the 3D display, but only hatched regions for respective viewpoints are displayed. In this embodiment, each of these regions will be referred to as an effective display range of the multi viewpoint image. The effective display range of each viewpoint depends on the panel configuration of the 3D display, and can be calculated from the display parameters 111.

In this embodiment, the multi viewpoint sprite high-frequency display range 2105 is defined by the 2σ-wide region having the average μ of the values of the line buffer as the center. However, the width of the multi viewpoint sprite high-frequency display range 2105 is not limited to 2σ, and may be changed according to the shape and moving range of a multi viewpoint sprite.

In this embodiment, in step S2003, the sprite display position-dependent parallax image priority determination unit 1701 executes the processing for incrementing, by one, the values of the line buffer within the range between the minimum x-coordinate value x_min and maximum x-coordinate value x_max of non-transparent effective pixels in the sprite image. However, a value to be added may be weighted according to an actual shape of a multi viewpoint sprite. For example, when a multi viewpoint sprite exists mainly on the right side of the display region 1802, a larger value may be added to the right side of the line buffer within the range between the minimum x-coordinate value x_min and maximum x-coordinate value x_max of non-transparent effective pixels in the sprite image.

Of the multi viewpoint images 2202, images for viewpoints, the effective display range of which includes the multi viewpoint sprite high-frequency display range, are held at a high resolution, and those for other viewpoints are held at a low resolution. This does not cause any serious visual deterioration, and the data size of the overall multi viewpoint sprite can be reduced.

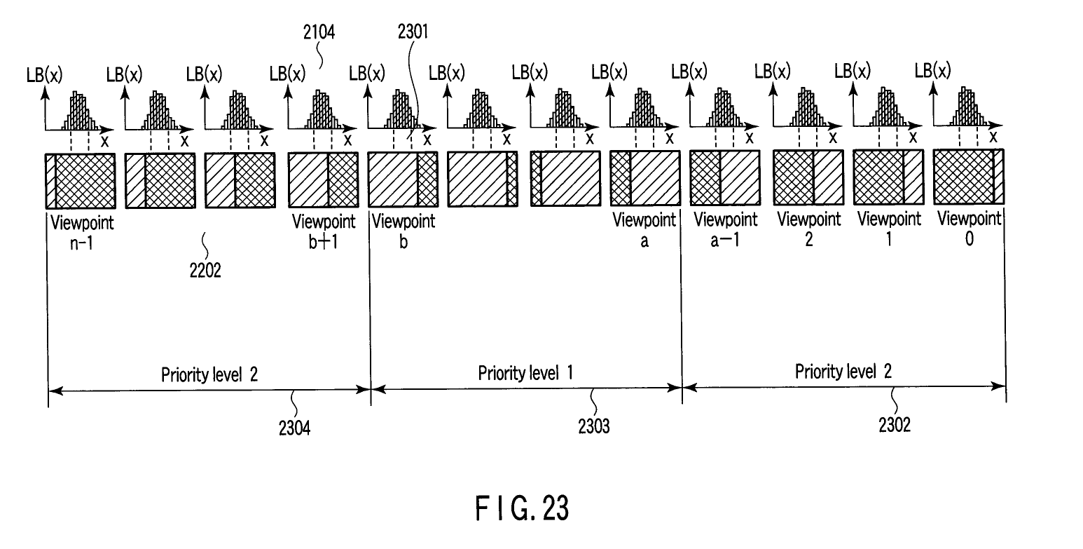

A method of generating the parallax image priority information 113 from the display regions of the multi viewpoint images 2202 and the histograms 2104 will be described below with reference to FIG. 23.

For respective viewpoints, the multi viewpoint images, the effective display range of which includes the multi viewpoint sprite high-frequency display range as the hatched portion of the histogram 2104, as denoted by reference numeral 2301, are detected. In the example of FIG. 23, viewpoints from viewpoint a to viewpoint b meet the aforementioned condition. For this reason, viewpoints 2303 within this range are set to have “priority level 1” indicating the highest priority. On the other hand, viewpoints 2302 from viewpoint 0 to viewpoint a−1, and viewpoints 2304 within a range from viewpoint b+1 to viewpoint n−1 are set to have “priority level 2”, indicating the priority lower than priority level 1. In this way, the priority levels are substituted for respective P(i) of the parallax image priority information 113.

In the third embodiment, the processing of the subsequent units of the sprite display position-dependent parallax image priority determination unit 1701 is common to the first embodiment.

### Effect of Third Embodiment

In this embodiment, multi viewpoint sprite data is generated by reading out a multi-resolution-level, multi viewpoint sprite, which is defined to have different resolutions for respective viewpoints, from the multi-resolution-level, multi viewpoint image storage unit based on the sprite display position information calculated based on the display position information of the multi viewpoint sprite, and a given multi viewpoint sprite data size threshold.

When sprite images of viewpoints to be rendered are to be held at a high resolution, and when the multi viewpoint sprite data size exceeds the multi viewpoint sprite data size threshold, the multi parallax image generation apparatus of this embodiment can be used to configure a multi viewpoint sprite within a data size that does not exceed the multi viewpoint sprite data size threshold without visually considerably deteriorating a screen image of the sprite, in such a manner that a sprite image of a high resolution is selected for a region where the multi viewpoint sprite is displayed at higher frequencies and a sprite image of a low resolution is selected for a region where the multi viewpoint sprite is displayed at lower frequencies.

Note that this embodiment may be practiced in pre-processing of execution of a 3D display application using a multi viewpoint sprite.

This embodiment targets at the 3D display which generates a parallax only in the horizontal direction, and configures a multi-resolution-level, multi viewpoint sprite for one dimension in the horizontal direction. However, this embodiment can be practiced for a 3D display which generates disparities in the horizontal and vertical directions by applying the contents of this embodiment to two dimensions, i.e., the vertical and horizontal directions.

### Fourth Embodiment

This embodiment will exemplify an apparatus, which reads out a multi viewpoint sprite from a multi viewpoint sprite storage unit, and renders it at the designated position so as to present the multi viewpoint sprite as an autostereoscopic image, in addition to the arrangement of the third embodiment.

[Arrangement of Apparatus]

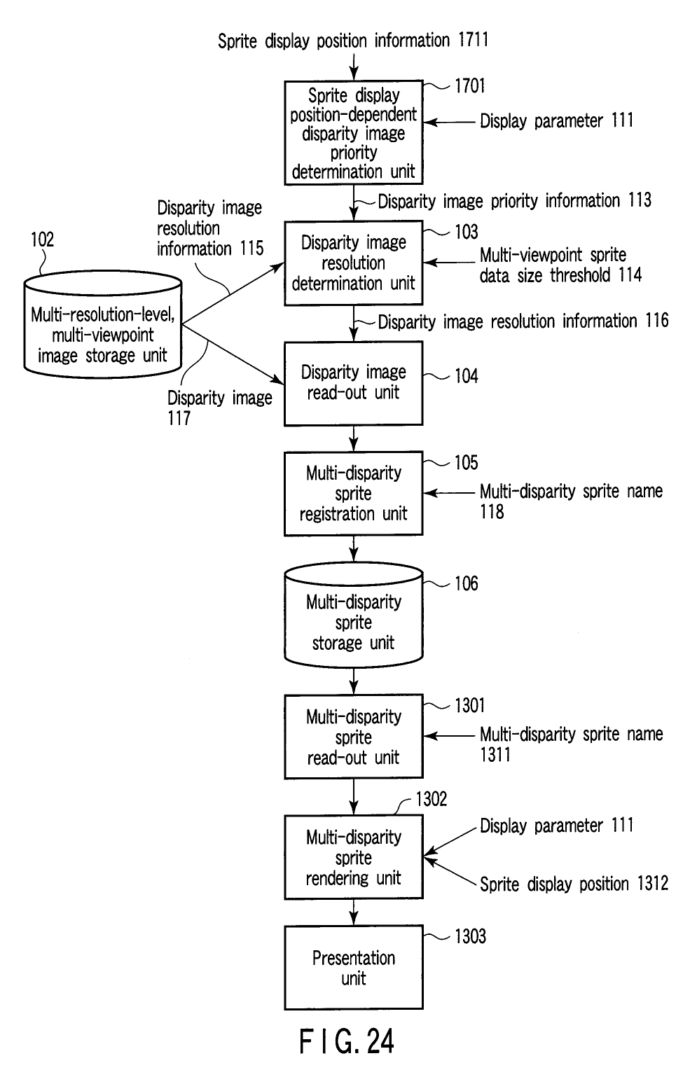

A multi parallax image generation apparatus of this embodiment will be described below with reference to FIG. 24.

The multi parallax image generation apparatus of this embodiment is prepared by adding the multi viewpoint sprite read-out unit 1301, multi viewpoint sprite rendering unit 1302, and presentation unit 1303 of the second embodiment to the multi parallax image generation apparatus of the third embodiment.

### Effect of Fourth Embodiment

This embodiment generates multi viewpoint sprite data by reading out a multi-resolution-level, multi viewpoint sprite, which is defined to have different resolutions for respective viewpoints, from the multi-resolution-level, multi viewpoint image storage unit based on parallax image priority information calculated based on the display position information of the multi viewpoint sprite, and a given multi viewpoint sprite data size threshold, and presents the generated multi viewpoint sprite at an arbitrary position on the 3D display.

When sprite images of viewpoints to be rendered are to be held at a high resolution, and when the multi viewpoint sprite data size exceeds the multi viewpoint sprite data size threshold, the multi parallax image generation apparatus of this embodiment can be used to configure a multi viewpoint sprite within a data size that does not exceed the multi viewpoint sprite data size threshold and can display it on the 3D display without visually considerably deteriorating a screen image of the sprite, in such a manner that a sprite image of a high resolution is selected for a region where the multi viewpoint sprite is displayed at higher frequencies and a sprite image of a low resolution is selected for a region where the multi viewpoint sprite is displayed at lower frequencies.

Upon practicing this embodiment on a personal computer, a multi viewpoint sprite image 1401 in the multi viewpoint sprite rendering unit 1302 is stored in a video memory. Since the occupied video memory size per multi viewpoint sprite is reduced according to this embodiment, the video memory can store many types of multi viewpoint sprites compared to a case in which sprite images of viewpoints to be rendered are held at a high resolution.

In terms of limitations on the data transfer rate of the video memory, by reducing the occupied video memory size per multi viewpoint sprite, a time required per multi viewpoint sprite for data transfer from a texture memory to the frame buffer is reduced compared to a case in which sprite images of viewpoints to be rendered are held at a high resolution. As a result, a time required to render the multi viewpoint sprite can be shortened, and the processing of an application using the multi viewpoint sprite can be speeded up.

This embodiment may be practiced in pre-processing of that of a 3D display application using a multi viewpoint sprite. By applying this embodiment to a scene graph processing unit in the 3D display application, the configuration of a multi viewpoint sprite can be dynamically changed in accordance with the state of the application such as a video memory consumption amount of graphics hardware and the like during execution of the application.

This embodiment is targeted at the 3D display which generates a parallax only in the horizontal direction, and configures a multi-resolution-level, multi viewpoint sprite for one dimension in the horizontal direction. However, this embodiment can be practiced for a 3D display which generates disparities in the horizontal and vertical directions by applying the contents of this embodiment to two dimensions in the vertical and horizontal directions.

### Fifth Embodiment

This embodiment will exemplify an apparatus, which receives viewing area priority information, sprite display position information in a screen, and display parameters as inputs, determines resolutions for respective viewpoints of a multi viewpoint sprite depending on the viewing area priority information and sprite display position information, configures a multi viewpoint sprite by selectively reading out images of the respective viewpoints from a multi-resolution-level, multi viewpoint image storage unit based on that multi-viewpoint resolution information, and registers the multi viewpoint sprite in a multiviewpoint sprite storage unit by appending a multi-viewpoint sprite name to it.

[Arrangement of Apparatus]

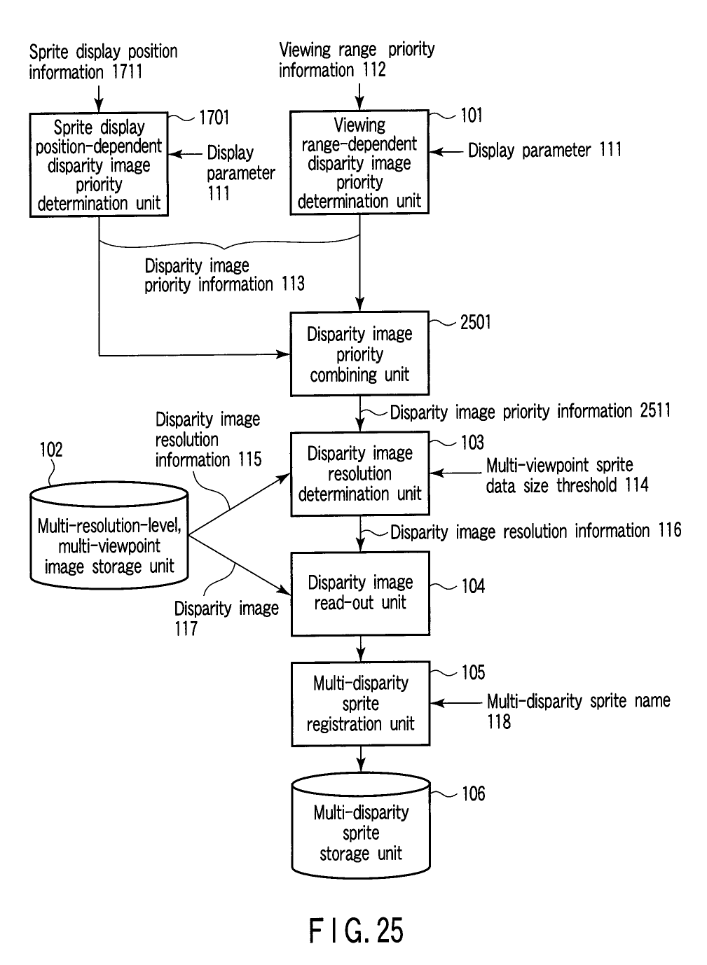

A multi parallax image generation apparatus of this embodiment will be described below with reference to FIG. 25.

In this embodiment, the sprite display position-dependent parallax image priority determination unit 1701 of the third embodiment, and a parallax image priority combining unit 2501 that combines the output of a viewing area-dependent parallax image priority determination unit 101 and that of the sprite display position-dependent parallax image priority determination unit 1701 are added to the arrangement of the first embodiment.

The parallax image priority combining unit 2501 receives parallax image priority information 113 as an output of the sprite display position-dependent parallax image priority determination unit 1701, and parallax image priority information 113 as an output of the viewing area-dependent parallax image priority determination unit 101 as inputs, executes combining processing of the two pieces of parallax image priority information, and outputs parallax image priority information 2511.

Of this apparatus, the viewing area-dependent parallax image priority determination unit 101, a multi-resolution-level, multi viewpoint image storage unit 102, parallax image resolution determination unit 103, parallax image read-out unit 104, multi viewpoint sprite storage unit 106, and multi viewpoint sprite registration unit 105 are the same as those described in the first embodiment, and a repetitive description thereof will be avoided in this embodiment. Likewise, of this apparatus, the sprite display position-dependent parallax image priority determination unit 1701 is the same as that described in the third embodiment, and a repetitive description thereof will be avoided in this embodiment.

[Processing Contents of Parallax Image Priority Combining Unit 2501]

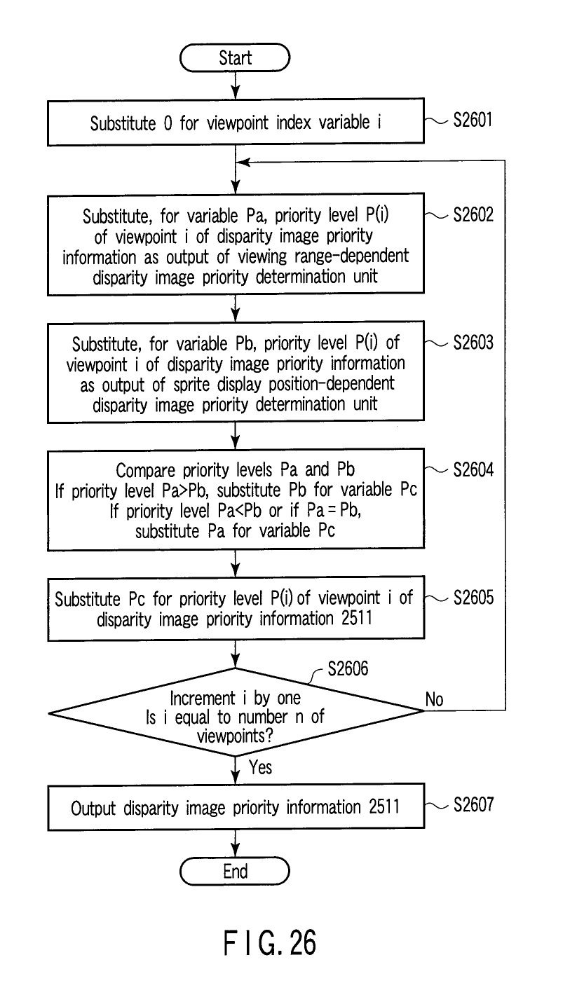

The processing sequence of the parallax image priority combining unit 2501 will be described below with reference to FIG. 26. Upon practicing this embodiment on a personal computer, the parallax image priority combining unit 2501 is a program implemented on a CPU. Note that the structures of all of the parallax image priority information 113 as an output of the sprite display position-dependent parallax image priority determination unit 1701, the parallax image priority information 113 as an output of the viewing area-dependent parallax image priority determination unit 101, and the parallax image priority information 2511 are the same as that of the information 113 shown in FIG. 7.

(Step S2601) The parallax image priority combining unit 2501 substitutes “0” for a viewpoint index variable i for loop processing.

(Step S2602) The parallax image priority combining unit 2501 substitutes, for a variable Pa, priority level P(i) for viewpoint i in the parallax image priority information 113 as an output of the viewing area-dependent parallax image priority determination unit 101.

(Step S2603) The parallax image priority combining unit 2501 substitutes, for a variable Pb, priority level P(i) for viewpoint i in the parallax image priority information 113 as an output of the sprite display position-dependent parallax image priority determination unit 1701.

(Step S2604) The parallax image priority combining unit 2501 compares two priority levels, Pa and Pb. If Pa stores a priority level higher than Pb, the unit 2501 substitutes Pb as a lower priority level for a variable Pc. On the other hand, if Pa stores a priority level lower than Pb, the unit 2501 substitutes Pa as a lower priority level for the variable Pc. If Pa and Pb store an equal priority level, the unit 2501 substitutes Pa for Pc. For example, when Pa stores “priority level 1” and Pb stores “priority level 2”, “priority level 2” is substituted for Pc.

(Step S2605) The parallax image priority combining unit 2501 substitutes Pc for priority level P(i) for viewpoint i in the parallax image priority information 2511.

(Step S2606) The parallax image priority combining unit 2501 increments the viewpoint index variable i by one. The unit 2501 checks if i is equal to the number n of viewpoints. If i is equal to the number n of viewpoints, the process advances to step S2607; otherwise, the process returns to step S2602.

(Step S2607) Finally, the parallax image priority combining unit 2501 outputs the parallax image priority information 2511, thus ending the processing.

In this manner, the parallax image priority combining unit 2501 combines the two pieces of priority information for respective parallax images output from both the viewing area-dependent parallax image priority determination unit 101 and sprite display position-dependent parallax image priority determination unit 1701.

In this embodiment, a method of outputting, for each viewpoint, a lower priority level of parallax image priority levels output from the viewing area-dependent parallax image priority determination unit 101 and sprite display position-dependent parallax image priority determination unit 1701 has been described. However, the present invention is not limited to this method, and a higher one of the two priority levels may be output. Also, an intermediate priority level of the two priority levels may be calculated and output.

### Effect of Fifth Embodiment

This embodiment combines parallax image priority information defined based on the viewing area of the 3D display in the first embodiment and that calculated based on the multi viewpoint sprite display position information in the third embodiment, and generates multi viewpoint sprite data by reading out a multi-resolution-level, multi viewpoint sprite, which is defined to have different resolutions for respective viewpoints, from the multi-resolution-level, multi viewpoint image storage unit based on a given multi viewpoint sprite data size threshold.

When sprite images of viewpoints to be rendered are to be held at a high resolution, and when the multi viewpoint sprite data size exceeds the multi viewpoint sprite data size threshold, the multi parallax image generation apparatus of this embodiment can be used to configure a multi viewpoint sprite within a data size that does not exceed the multi viewpoint sprite data size threshold without visually considerably deteriorating a screen image of the sprite in association with regions where the multi viewpoint sprite is displayed at higher frequencies.

This embodiment may be practiced in pre-processing of execution of a 3D display application using a multi viewpoint sprite.

This embodiment targets at the 3D display which generates a parallax only in the horizontal direction, and configures a multi-resolution-level, multi viewpoint sprite for one dimension in the horizontal direction. However, this embodiment can be practiced for a 3D display which generates disparities in the horizontal and vertical directions by applying the contents of this embodiment to two dimensions, i.e., the vertical and horizontal directions.

### Sixth Embodiment

This embodiment will exemplify an apparatus, which reads out a multi viewpoint sprite from a multi viewpoint sprite storage unit, renders it at the designated position, and presents the multi viewpoint sprite as an autostereoscopic image, as described in the second embodiment, in addition to the arrangement of the fifth embodiment.

[Arrangement of Apparatus]

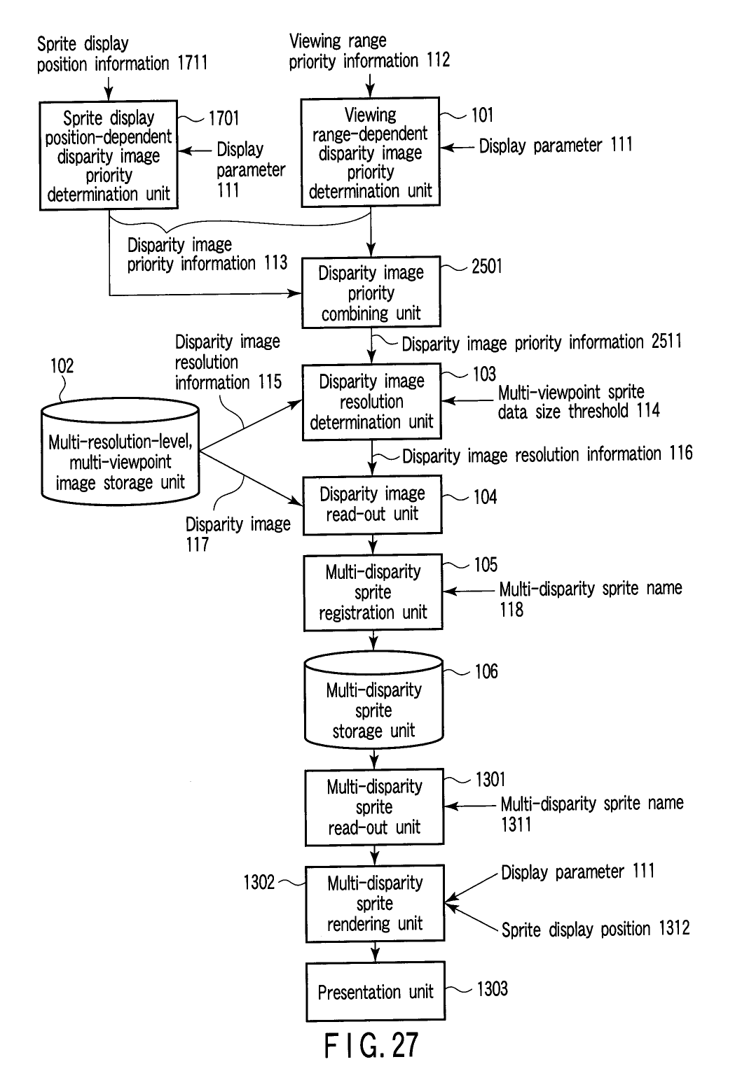

A multi parallax image generation apparatus of this embodiment will be described below with reference to FIG. 27.

This apparatus is prepared by adding a multi viewpoint sprite read-out unit 1301, multi viewpoint sprite rendering unit 1302, and presentation unit 1303 to the apparatus of the fifth embodiment shown in FIG. 25. Since all these units have been explained in the second embodiment, a repetitive description thereof will be avoided.

### Effect of Sixth Embodiment

This embodiment combines parallax image priority information defined based on the viewing area of the 3D display in the first embodiment and that calculated based on the multi viewpoint sprite display position information in the third embodiment, generates multi viewpoint sprite data by reading out a multi-resolution-level, multi viewpoint sprite, which is defined to have different resolutions for respective viewpoints, from the multi-resolution-level, multi viewpoint image storage unit based on a given multi viewpoint sprite data size threshold, and presents the generated multi viewpoint sprite at an arbitrary position on the 3D display.

When sprite images of viewpoints to be rendered are to be held at a high resolution, and when the multi viewpoint sprite data size exceeds the multi viewpoint sprite data size threshold, the image parallax image generation apparatus of this embodiment can be used to configure a multi viewpoint sprite within a data size that does not exceed the multi viewpoint sprite data size threshold without visually considerably deteriorating a screen image of the sprite in association with regions where the multi viewpoint sprite is displayed at higher frequencies, when the viewpoint of the viewer exists at the center of the viewing area at higher frequencies.

Upon practicing this embodiment on a personal computer, a multi viewpoint sprite image 1401 in the multi viewpoint sprite rendering unit 1302 is stored in a video memory. Since the occupied video memory size per multi viewpoint sprite is reduced according to this embodiment, the video memory can store many types of multi viewpoint sprites compared to a case in which sprite images of viewpoints to be rendered are held at a high resolution.

In terms of limitations on the data transfer rate of the video memory, by reducing the occupied video memory size per multi viewpoint sprite, a time required per multi viewpoint sprite for data transfer from a texture memory to the frame buffer is reduced compared to a case in which sprite images of viewpoints to be rendered are held at a high resolution. As a result, a time required to render the multi viewpoint sprite can be shortened, and the processing of an application using the multi viewpoint sprite can be speeded up.

This embodiment may be practiced in pre-processing of that of a 3D display application using a multi viewpoint sprite. By applying this embodiment to a scene graph processing unit in the 3D display application, the configuration of a multi viewpoint sprite can be dynamically changed in accordance with the state of the application such as a video memory consumption amount of graphics hardware and the like during execution of the application.

According to the aforementioned embodiments, when the viewpoint of the viewer exists at the center of the viewing area at higher frequencies, a screen image of a multi viewpoint sprite is presented without being visually serially deteriorated such that a sprite image of a high resolution is selected for a viewpoint of a high viewing area priority level, while a sprite image of a low resolution is selected for a viewpoint of a low viewing area priority level. Hence, the video memory size occupied by the multi viewpoint sprite can be reduced compared to a case in which a multi viewpoint sprite is held in the video memory at a high resolution in association with viewpoints to be rendered.

Note that installation in a next-generation graphics processing engine, and that in middleware for a 3D display rendering engine can be expected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multi parallax image generation apparatus comprising:
a first acquisition unit configured to acquire number of first viewpoints and positions of the first viewpoints from display parameters, and to generate parallax image priority information which defines priority levels for each of the first viewpoints with reference to viewing area priority information given with priority levels in association with positions on a line separated by a viewing distance from a three-dimensional display;
a first storage unit configured to store a plurality of first parallax images at the first viewpoints for first resolution levels;
a first generation unit configured to generate parallax image resolution information, which defines the first resolution levels of the first parallax images for the first viewpoints, by setting second resolution levels to be a higher-resolution level in association with second viewpoints to be rendered, and by re-setting, if a sum total of data sizes of second parallax images of the second viewpoints exceeds a threshold, the second resolution levels of the second viewpoints with lower priority levels to be a low-resolution level until the sum total becomes not more than the threshold, the second viewpoints being included in the first viewpoints;
a first read-out unit configured to read out third parallax images corresponding to the re-set second resolution levels for the second viewpoints from the first storage unit based on the parallax image resolution information; and
a second storage unit configured to store the third parallax images in association with the second viewpoints.

2. The apparatus according to claim 1, the second storage unit configured to storage the third parallax images for the second viewpoints in association with a multi parallax name.

3. The apparatus according to claim 1, further comprising:
a second read-out unit configured to read out the third parallax images corresponding to a multi parallax name;
a rendering unit configured to render the third parallax images on a frame memory in association with the display parameters and display position information that designates display positions of the third parallax images; and
a presentation unit configured to present the third parallax images rendered on the frame memory.

4. A multi parallax image generation apparatus comprising:
a second acquisition unit configured to acquire number of first viewpoints and positions of the first viewpoints from display parameters, to accumulate a plurality of frequencies of locations of first parallax images for display positions with reference to display position information which indicates the display positions of the first parallax images in association with times, and to generate parallax image priority information which defines priority levels according to the frequencies for each of the first viewpoints;
a first storage unit configured to store a plurality of second parallax images at the first viewpoints for first resolution levels;
a first generation unit configured to generate parallax image resolution information, which defines the first resolution levels of the second parallax images for the first viewpoints, by setting second resolution levels to be a higher-resolution level in association with second viewpoints to be rendered, and by re-setting, if a sum total of data sizes of third parallax images of the second viewpoints exceeds a threshold, the second resolution levels of the second viewpoints with lower priority levels to be a low-resolution level until the sum total becomes not more than the threshold, the second viewpoints being included in the first viewpoints;
a first read-out unit configured to read out fourth parallax images corresponding to the re-set second resolution levels for the second viewpoints from the first storage unit based on the parallax image resolution information; and
a second storage unit configured to store the fourth parallax images in association with the second viewpoints.

5. The apparatus according to claim 4, the second storage unit configured to storage the fourth parallax images for the second viewpoints in association with a multi disparity name.

6. The apparatus according to claim 4, further comprising:
a second read-out unit configured to read out the fourth parallax images corresponding to a multi disparity name;
a rendering unit configured to render the fourth parallax images on a frame memory in association with the display parameters and display position information that designates display positions of the fourth parallax images; and
a presentation unit configured to present the fourth parallax images rendered on the frame memory.

7. A multi parallax image generation apparatus comprising:
a first acquisition unit configured to acquire number of first viewpoints and positions of the first viewpoints from display parameters, and to generate first parallax image priority information which defines priority levels for each of the first viewpoints with reference to viewing area priority information given with priority levels in association with positions on a line separated by a viewing distance from a three-dimensional display;
a second acquisition unit configured to acquire number of second viewpoints and the positions of the second viewpoints from the display parameters, to accumulate a plurality of frequencies of locations of first parallax images for display positions with reference to display position information which indicates the display positions of the first parallax images in association with times, and to generate second parallax image priority information which defines priority levels according to the frequencies for each of the second viewpoints;
a second generation unit configured to generate third parallax image priority information which defines priority levels corresponding to one of the first parallax image priority information and the second parallax image priority information for each of third viewpoints, the third viewpoints being included in the first viewpoints and the second viewpoints;
a first storage unit configured to store a plurality of second parallax images at the third viewpoints for first resolution levels;
a first generation unit configured to generate parallax image resolution information, which defines the first resolution levels of the second parallax images for the third viewpoints, by setting second resolution levels to be a higher-resolution level in association with fourth viewpoints to be rendered, and by re-setting, if a sum total of data sizes of third parallax images of the fourth viewpoints exceeds a threshold, the second resolution levels of the fourth viewpoints with lower priority levels to be a low-resolution level until the sum total becomes not more than the threshold, the fourth viewpoints being included in the third viewpoints;
a first read-out unit configured to read out fourth parallax images corresponding to the re-set second resolution levels for the fourth viewpoints from the first storage unit based on the parallax image resolution information; and
a second storage unit configured to store the fourth parallax images in association with the fourth viewpoints.

8. The apparatus according to claim 7, wherein the second storage unit configured to storage the fourth parallax images for the fourth viewpoints in association with a multi disparity name.

9. The apparatus according to claim 7, further comprising:
a second read-out unit configured to read out the fourth parallax images corresponding to a multi disparity name;
a rendering unit configured to render the fourth parallax images on a frame memory in association with the display parameters and display position information that designates display positions of the fourth parallax images; and
a presentation unit configured to present the fourth parallax images rendered on the frame memory.
